(19) United States
(12) Patent Application Publication
(10) Pub. No.: US 2006/0117077 A1
(43) Pub. Date: Jun. 1, 2006

(54) Method for identifying a subset of components of a system

(76) Inventors: Harri Kiiveri, Campbell (AU); Albert Trajstman, Campbell (AU)

Correspondence Address: LADAS & PARRY LLP, 224 SOUTH MICHIGAN AVENUE, SUITE 1600, CHICAGO, IL, 60604, US

(21) Appl. No.: 10/552,782

(22) PCT Filed: May 26, 2004
(86) PCT No.: PCT/AU04/00696

§ 371 Date: Jan. 23, 2006

(30) Foreign Application Priority Data
May 26, 2003 (AU) 2003902589

(51) Int. Cl. G06F 15/00

(52) U.S. Cl. 708/200

(57) ABSTRACT

A method of identifying a subset of components of a system based on data obtained from the system using at least one training sample from the system, the method comprising the steps of: obtaining a linear combination of components of the system and weightings of the linear combination of components, the weightings having values based on data obtained from the at least one training sample, the at least one training sample having a known feature; obtaining a model of a probability distribution of the known feature, wherein the model is conditional on the linear combination of components; obtaining a prior distribution for the weighting of the linear combination of the components, the prior distribution comprising a hyperprior having a high probability density close to zero, the hyperprior being such that it is not a Jeffreys hyperprior, combining the prior distribution and the model to generate a posterior distribution; and identifying the subset of components based on a set of the weightings that maximise the posterior distribution.

### FIELD OF THE INVENTION

The present invention relates to a method and apparatus for identifying components of a system from data generated from samples from the system, which components are capable of predicting a feature of the sample within the system and, particularly, but not exclusively, the present invention relates to a method and apparatus for identifying components of a biological system from data generated by a biological method, which components are capable of predicting a feature of interest associated with a sample applied to the biological system.

### BACKGROUND OF THE INVENTION

There are any number of systems in existence that can be classified according to one or more features thereof. The term “system” as used throughout this specification is considered to include all types of systems from which data (e.g. statistical data) can be obtained. Examples of such systems include chemical systems, financial systems and geological systems. It is desirable to be able to utilise data obtained from the systems to identify particular features of samples from the system; for instance, to assist with analysis of financial system to identify groups such as those who have good credit and those who are a credit risk. Often the data obtained from the systems is relatively large and therefore it is desirable to identify components of the systems from the data, the components being predictive of the particular features of the samples from the system. However, when the data is relatively large it can be difficult to identify the components because there is a large amount of data to process, the majority of which may not provide any indication or little indication of the features of a particular sample from which the data is taken. Furthermore, components that are identified using a training sample are often ineffective at identifying features on test sample data when the test sample data has a high degree of variability relative to the training sample data. This is often the case in situations when, for example, data is obtained from many different sources, as it is often difficult to control the conditions under which the data is collected from each individual source.

An example of a type of system where these problems are particularly pertinent, is a biological system, in which the components could include, for example, particular genes or proteins. Recent advances in biotechnology have resulted in the development of biological methods for large scale screening of systems and analysis of samples. Such methods include, for example, microarray analysis using DNA or RNA, proteomics analysis, proteomics electrophoresis gel analysis, and high throughput screening techniques. These types of methods often result in the generation of data that can have up to 30,000 or more components for each sample that is tested.

It is highly desirable to be able identify features of interest in samples from biological systems. For example, to classify groups such as “diseased” and “non-diseased”. Many of these biological methods would be useful as diagnostic tools predicting features of a sample in the biological systems. For example, identifying diseases by screening tissues or body fluids, or as tools for determining, for example, the efficacy of pharmaceutical compounds.

Use of biological methods such as biotechnology arrays in such applications to date has been limited due to the large amount of data that is generated from these types of methods, and the lack of efficient methods for screening the data for meaningful results. Consequently, analysis of biological data using existing methods is time consuming, prone to false results and requires large amounts of computer memory if a meaningful result is to be obtained from the data. This is problematic in large scale screening scenarios where rapid and accurate screening is required.

It is therefore desirable to have a method, in particular for analysis of biological data, and more generally, for an improved method of analysing data from a system in order to predict a feature of interest for a sample from the system.

### SUMMARY OF THE INVENTION

According to a first aspect of the present invention, there is provided a method of identifying a subset of components of a system based on data obtained from the system using at least one training sample from the system, the method comprising the steps of:

obtaining a linear combination of components of the system and weightings of the linear combination of components, the weightings having values based on the data obtained from the system using the at least one training sample, the at least one training sample having a known feature;

obtaining a model of a probability distribution of the known feature, wherein the model is conditional on the linear combination of components;

obtaining a prior distribution for the weighting of the linear combination of the components, the prior distribution comprising a hyperprior having a high probability density close to zero, the hyperprior being such that it is not a Jeffreys hyperprior;

combining the prior distribution and the model to generate a posterior distribution; and

identifying the subset of components based on a set of the weightings that maximise the posterior distribution.

The method utilises training samples having the known feature in order to identify the subset of components which can predict a feature for a training sample. Subsequently, knowledge of the subset of components can be used for tests, for example clinical tests, to predict a feature such as whether a tissue sample is malignant or benign, or what is the weight of a tumour, or provide an estimated time for survival of a patient having a particular condition.

The term “feature” as used throughout this specification refers to any response or identifiable trait or character that is associated with a sample. For example, a feature may be a particular time to an event for a particular sample, or the size or quantity of a sample, or the class or group into which a sample can be classified.

Preferably, the step of obtaining the linear combination comprises the step of using a Bayesian statistical method to estimate the weightings.

Preferably, the method further comprises the step of making an apriori assumption that a majority of the components are unlikely to be components that will form part of the subset of components.

The apriori assumption has particular application when there are a large amount of components obtained from the system. The apriori assumption is essentially that the majority of the weightings are likely to be zero. The model is constructed such that with the apriori assumption in mind, the weightings are such that the posterior probability of the weightings given the observed data is maximised. Components having a weighting below a pre-determined threshold (which will be the majority of them in accordance with the apriori assumption) are ignored. The process is iterated until the correct diagnostic components are identified. Thus, the method has the potential to be quick, mainly because of the apriori assumption, which results in rapid elimination of the majority of components.

Preferably, the hyperprior comprises one or more adjustable parameter that enable the prior distribution near zero to be varied.

Most features of a system typically exhibit a probability distribution, and the probability distribution of a feature can be modelled using statistical models that are based on the data generated from the training samples. The present invention utilises statistical models that model the probability distribution for a feature of interest or a series of features of interest. Thus, for a feature of interest having a particular probability distribution, an appropriate model is defined that models that distribution.

Preferably, the method comprise a mathematical equation in the form of a likelihood function that provides the probability distribution based on data obtained from the at least one training sample.

Preferably, the likelihood function is based on a previously described model for describing some probability distribution.

Preferably, the step of obtaining the model comprises the step of selecting the model from a group comprising a multinomial or binomial logistic regression, generalised linear model, Cox's proportional hazards model, accelerated failure model and parametric survival model.

In a first embodiment, the likelihood function is based on the multinomial or binomial logistic regression. The binomial or multinomial logistic regression preferably models a feature having a multinomial or binomial distribution. A binomial distribution is a statistical distribution having two possible classes or groups such as an on/off state. Examples of such groups include dead/alive, improved/not improved, depressed/not depressed. A multinomial distribution is a generalisation of the binomial distribution in which a plurality of classes or groups are possible for each of a plurality of samples, or in other words, a sample may be classified into one of a plurality of classes or groups. Thus, by defining a likelihood function based on a multinomial or binomial logistic regression, it is possible to identify subsets of components that are capable of classifying a sample into one of a plurality of pre-defined groups or classes. To do this, training samples are grouped into a plurality of sample groups (or “classes”) based on a predetermined feature of the training samples in which the members of each sample group have a common feature and are assigned a common group identifier. A likelihood function is formulated based on a multinomial or binomial logistic regression conditional on the linear combination (which incorporates the data generated from the grouped training samples). The feature may be any desired classification by which the training samples are to be grouped. For example, the features for classifying tissue samples may be that the tissue is normal, malignant, benign, a leukemia cell, a healthy cell, that the training samples are obtained from the blood of patients having or not having a certain condition, or that the training samples are from a cell from one of several types of cancer as compared to a normal cell.

In the first embodiment, the likelihood function based on the multinomial or binomial logistic regression is of the form:

$$L = {\prod }_{i = 1}^{n} ( {\prod }_{g = 1}^{G - 1} {\{ \frac{{e}^{{x}_{i}^{T} {β}_{g}}}{( 1 + {\sum }_{g = 1}^{G - 1} {e}^{{x}_{i}^{T} {β}_{g}} )} \}}^{{e}_{ik}} {\{ \frac{1}{1 + {\sum }_{h = 1}^{G - 1} {e}^{{x}_{i}^{T} {β}_{h}}} \}}^{{e}_{iG}} )$$

wherein

xᵢ^{T} β_{g} is a linear combination generated from input data from training sample i with component weights β_{g};

xᵢ^{T} is the components for the i^{th} Row of X and β_{g} is a set of component weights for sample class g; and

X is data from n training samples comprising p components and the eᵢₖ are defined further in this specification.

In a second embodiment, the likelihood function is based on the ordered categorical logistic regression. The ordered categorical logistic regression models a binomial or multinomial distribution in which the classes are in a particular order (ordered classes such as for example, classes of increasing or decreasing disease severity). By defining a likelihood function based on an ordered categorical logistic regression, it is possible to identify a subset of components that is capable of classifying a sample into a class wherein the class is one of a plurality of predefined ordered classes. By defining a series of group identifiers in which each group identifier corresponds to a member of an ordered class, and grouping the training samples into one of the ordered classes based on predetermined features of the training samples, a likelihood function can be formulated based on a categorical ordered logistic regression which is conditional on the linear combination (which incorporates the data generated from the grouped training samples).

In the second embodiment, the likelihood function based on the categorical ordered logistic regression is of the form:

$$l = {\prod }_{i = 1}^{N} {\prod }_{k = 1}^{G - 1} {( \frac{{γ}_{ik}}{{γ}_{ik + 1}} )}^{{r}_{ik}} {( \frac{{γ}_{ik + 1} - {γ}_{ik}}{{γ}_{ik + 1}} )}^{{r}_{ik + 1} - {r}_{ik}}$$

Wherein

γᵢₖ is the probability that training sample i belongs to a class with identifier less than or equal to k (where the total of ordered classes is G). The rᵢ is defined further in the document.

In a third embodiment of the present invention, the likelihood function is based on the generalised linear model. The generalised linear model preferably models a feature that is distributed as a regular exponential family of distributions. Examples of regular exponential family of distributions include normal distribution, guassian distribution, poisson distribution, gamma distribution and inverse gaussian distribution. Thus, in another embodiment of the method of the invention, a subset of components is identified that is capable of predicting a predefined characteristic of a sample which has a distribution belonging to a regular exponential family of distributions. In particular by defining a generalised linear model which models the characteristic to be predicted. Examples of a characteristic that may be predicted using a generalised linear model include any quantity of a sample that exhibits the specified distribution such as, for example, the weight, size or other dimensions or quantities of a sample.

In the third embodiment, the generalised linear model is of the form:

$$L = log p ( y \vert β , ϕ ) = {\sum }_{i = 1}^{N} \{ \frac{{y}_{i} {θ}_{i} - b ( {θ}_{i} )}{{a}_{i} ( ϕ )} + c ( {y}_{i} , ϕ ) \}$$

where y=(y₁, . . . , yₙ)^{T} and aᵢ(φ)=φ/wᵢ with the wᵢ being a fixed set of known weights and φ a single scale parameter. The other terms in this expression are defined later in this document.

In a fourth embodiment, the method of the present invention may be used to predict the time to an event for a sample by utilising the likelihood function that is based on a hazard model, which preferably estimates the probability of a time to an event given that the event has not taken place at the time of obtaining the data. In the fourth embodiment, the likelihood function is selected from the group comprising a Cox's proportional hazards model, parametric survival model and accelerated failure times model. Cox's proportional hazards model permits the time to an event to be modelled on a set of components and component weights without making restrictive assumptions about time. The accelerated failure model is a general model for data consisting of survival times in which the component measurements are assumed to act multiplicatively on the time-scale, and so affect the rate at which an individual proceeds along the time axis. Thus, the accelerated survival model can be interpreted in terms of the speed of progression of, for example, disease. The parametric survival model is one in which the distribution function for the time to an event (eg survival time) is modelled by a known distribution or has a specified parametric formulation. Among the commonly used survival distributions are the Weibull, exponential and extreme value distributions.

In the fourth embodiment, a subset of components capable of predicting the time to an event for a sample is identified by defining a likelihood based on Cox's proportional standards model, a parametric survival model or an accelerated survival times model, which comprises measuring the time elapsed for a plurality of samples from the time the sample is obtained to the time of the event.

In the fourth embodiment, the likelihood function for predicting the time to an event is of the form:

$$Log ( Partial ) Likelihood = {\sum }_{i = 1}^{N} {g}_{i} ( {β}_{∼} , {φ}_{∼} ; X , {y}_{∼} , {c}_{∼} )$$

where {tilde under (β)}¹=(β₁,β₂, . . . ,βₚ) and {tilde under (φ)}¹ =(φ₁,φ₂, . . . ,φ_{q}) are the model parameters, y is a vector of observed times and c is an indicator vector which indicates whether a time is a true survival time or a censored survival time.

In the fourth embodiment, the likelihood function based on Cox's proportional hazards model is of the form:

$$l ( {t}_{∼} \vert {β}_{∼} ) = {\prod }_{j = 1}^{N} {( \frac{exp ( {Z}_{j} {β}_{∼} )}{{\sum }_{i ∈ {ℜ}_{j}} exp ( {Z}_{i} {β}_{∼} )} )}^{{d}_{j}}$$

where the observed times are be ordered in increasing magnitude denoted as {tilde under (t)}=(t₍₁₎,t₍₂₎, . . . ,t_{(N)}),t₍ᵢ₊₁₎>t₍ᵢ₎and Z denotes the Nxp matrix that is the re-arrangement of the rows of X where the ordering of the rows of Z corresponds to the ordering induced by the ordering of {tilde under (t)}. Also {tilde under (β)}^{T}=(β₁,β₂, . . . ,βₙ), zⱼ=the j^{th} row of z, and [symbol] ⱼ={i:i=j,j+1, . . . ,N}=the risk set at the j^{th} ordered event time t₍ⱼ₎.

In the fourth embodiment, wherein the likelihood function is based on the Parametric Survival model it is of the form:

$$L = {\sum }_{i = 1}^{N} \{ {c}_{i} log ( {μ}_{i} ) - {μ}_{i} + {c}_{i} ( log ( \frac{λ ( {y}_{i} )}{Λ ( {y}_{i} ; {φ}_{∼} )} ) ) \}$$

where μᵢ=Λ(yᵢ;{tilde under (φ)})exp(Xᵢ{tilde under (β)}) and Λ denotes the integrated parametric hazard function.

For any defined models, the weightings are typically estimated using a Bayesian statistical model (Kotz and Johnson, 1983) in which a posterior distribution of the component weights is formulated which combines the likelihood function and a prior distribution. The component weightings are estimated by maximising the posterior distribution of the weightings given the data generated for the at least one training sample. Thus, the objective function to be maximised consists of the likelihood function based on a model for the feature as discussed above and a prior distribution for the weightings.

Preferably, the prior distribution is of the form:

$$p ( β ) = {\int }_{{v}^{2}} p ( β \vert {v}^{2} ) p ( {v}^{2} ) ⅆ {v}^{2}$$

wherein v is a p×1 vector of hyperparameters, and where p(β|v²) is N(0,diag{v²}) and p(v²) is some hyperprior distribution for v².

Preferably, the hyperprior comprises a gamma distribution with a specified shape and scale parameter.

This hyperprior distribution (which is preferably the same for all embodiments of the method) may be expressed using different notational conventions, and in the detailed description of the embodiments (see below), the following notational conventions are adopted merely for convenience for the particular embodiment:

As used herein, when the likelihood function for the probability distribution is based on a multinomial or binomial logistic regression, the notation for the prior distribution is:

$$P ( {β}_{1} … , {β}_{i - 1} ) = {\int }_{{τ}^{2}} {\prod }_{g = 1}^{G - 1} P ( {β}_{g} \vert {τ}_{g}^{2} ) P ( {τ}_{g}^{2} ) ⅆ {τ}^{2}$$

where β^{T}=(β₁^{T},β_{G-1}^{T}) and τ^{T}=(τ₁^{T}, . . . ,τ_{G-1}^{T}). and p(β_{g}|τ_{g}²) is N(0,diag{τ_{g}²}) and P(τ_{g}²) is some hyperprior distribution for τ_{g}².

As used herein, when the likelihood function for the probability distribution is based on a categorical ordered logistic regression, the notation for the prior distribution is:

$$P ( {β}_{1} , {β}_{2} , ⋯ , {β}_{n} ) = {\int }_{τ} {\prod }_{i = 1}^{N} P ( {β}_{i} \vert {v}_{i}^{2} ) P ( {v}_{i}^{2} ) ⅆ {v}^{2}$$

where β₁,β₂, . . . ,βₙ are component weights, P(βᵢ|vᵢ) is N(0,vᵢ²) and P(vᵢ) some hyperprior distribution for vᵢ.

As used herein, when the likelihood function for the distribution is based on a generalised linear model, the notation for the prior distribution is:

$$p ( β ) = {\int }_{{τ}^{2}} p ( β \vert {v}^{2} ) p ( {v}^{2} ) ⅆ {v}^{2}$$

wherein v is a p×1 vector of hyperparameters, and where p(β|v²) is N(0,diag{v²}) and p(v²) is some prior distribution for v².

As used herein, when the likelihood function for the distribution is based on a hazard model, the notation for the prior distribution is:

where p(β*|τ) is N(0,diag{τ²}) and p(τ) some hyperprior distribution for τ.

The prior distribution comprises a hyperprior that ensures that zero weightings are used whenever possible.

$$p ( {β}^{*} ) = {\int }_{τ} p ( {β}^{*} \vert τ ) p ( τ ) ⅆ τ$$

In an alternative embodiment, the hyperprior is an inverse gamma distribution in which each tᵢ²=1/vᵢ² has an independent gamma distribution.

In a further alternative embodiment, the hyperprior is a gamma distribution in which each vᵢ²,τᵢ or τᵢ² (depending on the context) has an independent gamma distribution.

As discussed previously , the prior distribution and the likelihood function are combined to generate a posterior distribution. The posterior distribution is preferably of the form:
p(βφv|y)α L(y|βφ)p(β|v)p(v)
or
P({tilde under (β)},{tilde under (φ)},{tilde under (τ)}|{tilde under (y)})α L({tilde under (y)}|{tilde under (β)},{tilde under (φ)})P({tilde under (β)}|{tilde under (τ)})P({tilde under (τ)})
wherein L({tilde under (y)}|{tilde under (β)},{tilde under (φ)}) is the likelihood function.

Preferably, the step of identifying the subset of components comprises the step of using an iterative procedure such that the probability density of the posterior distribution is maximised.

During the iterative procedure, component weightings having a value less than a pre-determined threshold are eliminated, preferably by setting those component weights to zero. This results in the substantially elimination of the corresponding component.

Preferably, the iterative procedure is an EM algorithm.

The EM algorithm produces a sequence of component weighting estimates that converge to give component the weightings that maximise the probability density of the posterior distribution. The EM algorithm consists of two steps, known as the E or Expectation step and the M, or Maximisation step. In the E step, the expected value of the log-posterior function conditional on the observed data is determined. In the M step, the expected log-posterior function is maximised to give updated component weight estimates that increase the posterior. The two steps are alternated until convergence of the E step and the M step is achieved, or in other words, until the expected value and the maximised value of the expected log-posterior function converges.

It is envisaged that the method of the present invention may be applied to any system from which measurements can be obtained, and preferably systems from which very large amounts of data are generated. Examples of systems to which the method of the present invention may be applied include biological systems, chemical systems, agricultural systems, weather systems, financial systems including, for example, credit risk assessment systems, insurance systems, marketing systems or company record systems, electronic systems, physical systems, astrophysics systems and mechanical systems. For example, in a financial system, the samples may be particular stock and the components may be measurements made on any number of factors which may affect stock prices such as company profits, employee numbers, rainfall values in various cities, number of shareholders etc.

The method of the present invention is particularly suitable for use in analysis of biological systems. The method of the present invention may be used to identify subsets of components for classifying samples from any biological system which produces measurable values for the components and in which the components can be uniquely labelled. In other words, the components are labelled or organised in a manner which allows data from one component to be distinguished from data from another component. For example, the components may be spatially organised in, for example, an array which allows data from each component to be distinguished from another by spatial position, or each component may have some unique identification associated with it such as an identification signal or tag. For example, the components may be bound to individual carriers, each carrier having a detectable identification signature such as quantum dots (see for example, Rosenthal, 2001, Nature Biotech 19: 621-622; Han et al. (2001) Nature Biotechnology 19: 631-635), fluorescent markers (see for example, Fu et al, (1999) Nature Biotechnology 17: 1109-1111), bar-coded tags (see for example, Lockhart and trulson (2001) Nature Biotechnology 19: 1122-1123).

In a particularly preferred embodiment, the biological system is a biotechnology array. Examples of biotechnology arrays include oligonucleotide arrays, DNA arrays, DNA microarrays, RNA arrays, RNA microarrays, DNA microchips, RNA microchips, protein arrays, protein microchips, antibody arrays, chemical arrays, carbohydrate arrays, proteomics arrays, lipid arrays. In another embodiment, the biological system may be selected from the group including, for example, DNA or RNA electrophoresis gels, protein or proteomics electrophoresis gels, biomolecular interaction analysis such as Biacore analysis, amino acid analysis, ADMETox screening (see for example High-throughput ADMETox estimation: In Vitro and In Silico approaches (2002), Ferenc Darvas and Gyorgy Dorman (Eds), Biotechniques Press), protein electrophoresis gels and proteomics electrophoresis gels.

The components may be any measurable component of the system. In the case of a biological system, the components may be, for example, genes or portions thereof, DNA sequences, RNA sequences, peptides, proteins, carbohydrate molecules, lipids or mixtures thereof, physiological components, anatomical components, epidemiological components or chemical components.

The training samples may be any data obtained from a system in which the feature of the sample is known. For example, training samples may be data generated from a sample applied to a biological system. For example, when the biological system is a DNA microarray, the training sample may be data obtained from the array following hybridisation of the array with RNA extracted from cells having a known feature, or cDNA synthesised from the RNA extracted from cells, or if the biological system is a proteomics electrophoresis gel, the training sample may be generated from a protein or cell extract applied to the system.

It is envisaged that an embodiment of a method of the present invention may be used in re-evaluating or evaluating test data from subjects who have presented mixed results in response to a test treatment. Thus, there is a second aspect to the present invention.

The second aspect provides a method for identifying a subset of components of a subject which are capable of classifying the subject into one of a plurality of predefined groups, wherein each group is defined by a response to a test treatment, the method comprising the steps of:

exposing a plurality of subjects to the test treatment and grouping the subjects into response groups based on responses to the treatment;

measuring components of the subjects; and

identifying a subset of components that is capable of classifying the subjects into response groups using a statistical analysis method.

Preferably, the statistical analysis method comprises the method according to the first aspect of the present invention.

Once a subset of components has been identified, that subset can be used to classify subjects into groups such as those that are likely to respond to the test treatment and those that are not. In this manner, the method of the present invention permits treatments to be identified which may be effective for a fraction of the population, and permits identification of that fraction of the population that will be responsive to the test treatment.

According to a third aspect of the present invention, there is provided an apparatus for identifying a subset of components of a subject, the subset being capable of being used to classify the subject into one of a plurality of predefined response groups wherein each response group, is formed by exposing a plurality of subjects to a test treatment and grouping the subjects into response groups based on the response to the treatment, the apparatus comprising:

an input for receiving measured components of the subjects; and

processing means operable to identify a subset of components that is capable of being used to classify the subjects into response groups using a statistical analysis method.

Preferably, the statistical analysis method comprises the method according to the first or second aspect.

According to a fourth aspect of the present invention, there is provided a method for identifying a subset of components of a subject that is capable of classifying the subject as being responsive or non-responsive to treatment with a test compound, the method comprising the steps of:

exposing a plurality of subjects to the test compound and grouping the subjects into response groups based on each subjects response to the test compound;

measuring components of the subjects; and

identifying a subset of components that is capable of being used to classify the subjects into response groups using a statistical analysis method.

Preferably, the statistical analysis method comprises the method according to the first aspect.

According to a fifth aspect of the present invention, there is provided an apparatus for identifying a subset of components of a subject, the subset being capable of being used to classify the subject into one of a plurality of predefined response groups wherein each response group is formed by exposing a plurality of subjects to a compound and grouping the subjects into response groups based on the response to the compound, the apparatus comprising:

an input operable to receive measured components of the subjects;

processing means operable to identify a subset of components that is capable of classifying the subjects into response groups using a statistical analysis method.

Preferably, the statistical analysis method comprises the method according to the first or second aspect of the present invention.

The components that are measured in the second to fifth aspects of the invention may be, for example, genes or small nucleotide polymorphisms (SNPs), proteins, antibodies, carbohydrates, lipids or any other measurable component of the subject.

In a particularly embodiment of the fifth aspect, the compound is a pharmaceutical compound or a composition comprising a pharmaceutical compound and a pharmaceutically acceptable carrier.

The identification method of the present invention may be implemented by appropriate computer software and hardware.

According to a sixth aspect of the present invention, there is provided an apparatus for identifying a subset of components of a system from data generated from the system from a plurality of samples from the system, the subset being capable of being used to predict a feature of a test sample, the apparatus comprising:

a processing means operable to:

obtain a linear combination of components of the system and obtain weightings of the linear combination of components, each of the weightings having a value based on data obtained from at least one training sample, the at least one training sample having a known feature;

obtaining a model of a probability distribution of a second feature, wherein the model is conditional on the linear combination of components;

obtaining a prior distribution for the weightings of the linear combination of the components, the prior distribution comprising an adjustable hyperprior which allows the prior probability mass close to zero to be varied wherein the hyperprior is not a Jeffrey's hyperprior;

combining the prior distribution and the model to generate a posterior distribution; and

identifying the subset of components having component weights that maximize the posterior distribution.

Preferably, the processing means comprises a computer arranged to execute software.

According to a seventh aspect of the present invention, there is provided a computer program which, when executed by a computing apparatus, allows the computing apparatus to carry out the method according to the first aspect of the present invention.

The computer program may implement any of the preferred algorithms and method steps of the first or second aspect of the present invention which are discussed above.

According to an eighth aspect of the present invention, there is provided a computer readable medium comprising the computer program according with the seventh aspect of the present invention.

According to a ninth aspect of the present invention, there is provided a method of testing a sample from a system to identify a feature of the sample, the method comprising the steps of testing for a subset of components that are diagnostic of the feature, the subset of components having been determined by using the method according to the first or second aspect of the present invention.

Preferably, the system is a biological system.

According to a tenth aspect of the present invention, there is provided an apparatus for testing a sample from a system to determine a feature of the sample, the apparatus comprising means for testing for components identified in accordance with the method of the first or second aspect of the present invention.

According to an eleventh aspect of the present invention, there is provided a computer program which, when executed by on a computing device, allows the computing device to carry out a method of identifying components from a system that are capable of being used to predict a feature of a test sample from the system, and wherein a linear combination of components and component weights is generated from data generated from a plurality of training samples, each training sample having a known feature, and a posterior distribution is generated by combining a prior distribution for the component weights comprising an adjustable hyperprior which allows the probability mass close to zero to be varied wherein the hyperprior is not a Jeffrey's hyperprior, and a model that is conditional on the linear combination, to estimate component weights which maximise the posterior distribution.

Where aspects of the present invention are implemented by way of a computing device, it will be appreciated that any appropriate computer hardware e.g. a PC or a mainframe or a networked computing infrastructure, may be used.

According to a twelfth aspect of the present invention, there is provided a method of identifying a subset of components of a biological system, the subset being capable of predicting a feature of a test sample from the biological system, the method comprising the steps of:

obtaining a linear combination of components of the system and weightings of the linear combination of components, each of the weightings having a value based on data obtained from at least one training sample, the at least one training sample having a known first feature;

obtaining a model of a probability distribution of a second feature, wherein the model is conditional on the linear combination of components;

obtaining a prior distribution for the weightings of the linear combination of the components, the prior distribution comprising an adjustable hyperprior which allows the probability mass close to zero to be varied;

combining the prior distribution and the model to generate a posterior distribution; and

identifying the subset of components based on the weightings that maximize the posterior distribution.

### BRIEF DESCRIPTION OF THE DRAWINGS

Notwithstanding any other embodiments that may fall within the scope of the present invention, an embodiment of the present invention will now be described, by way of example only, with reference to the accompanying figures, in which:

FIG. 1 provides a flow chart of a method according to the embodiment of the present invention;

FIG. 2 provides a flow chart of another method according to the embodiment of the present invention;

FIG. 3 provides a block diagram of an apparatus according to the embodiment of the present invention;

FIG. 4 provides a flow chart of a further method according to the embodiment of the present invention;

FIG. 5 provides a flow chart of an additional method according to the embodiment of the present invention; and

FIG. 6 provides a flow chart of yet another method according to the embodiment of the present invention.

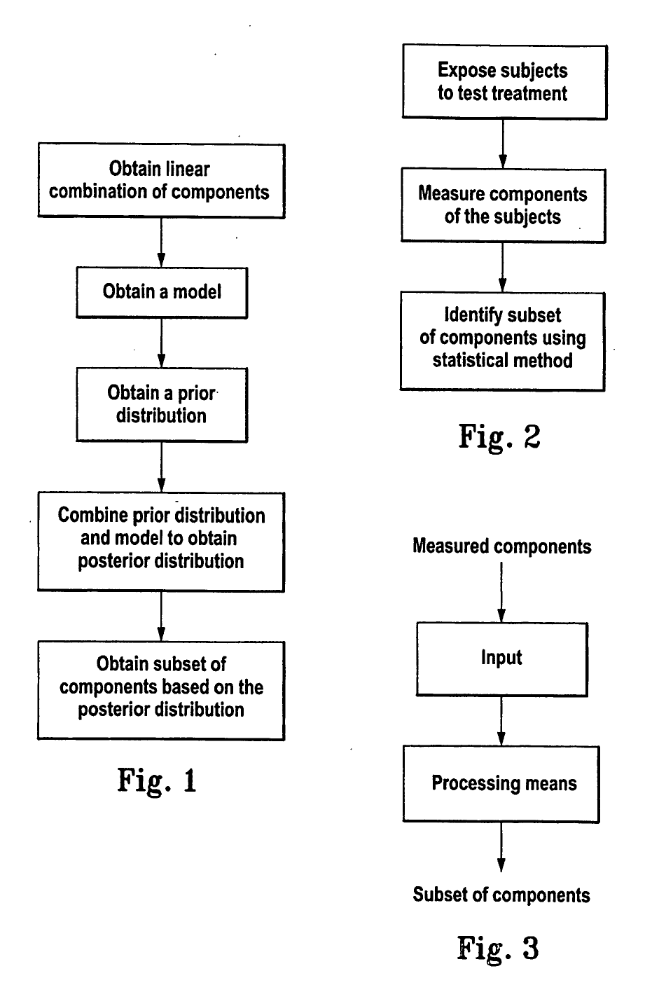

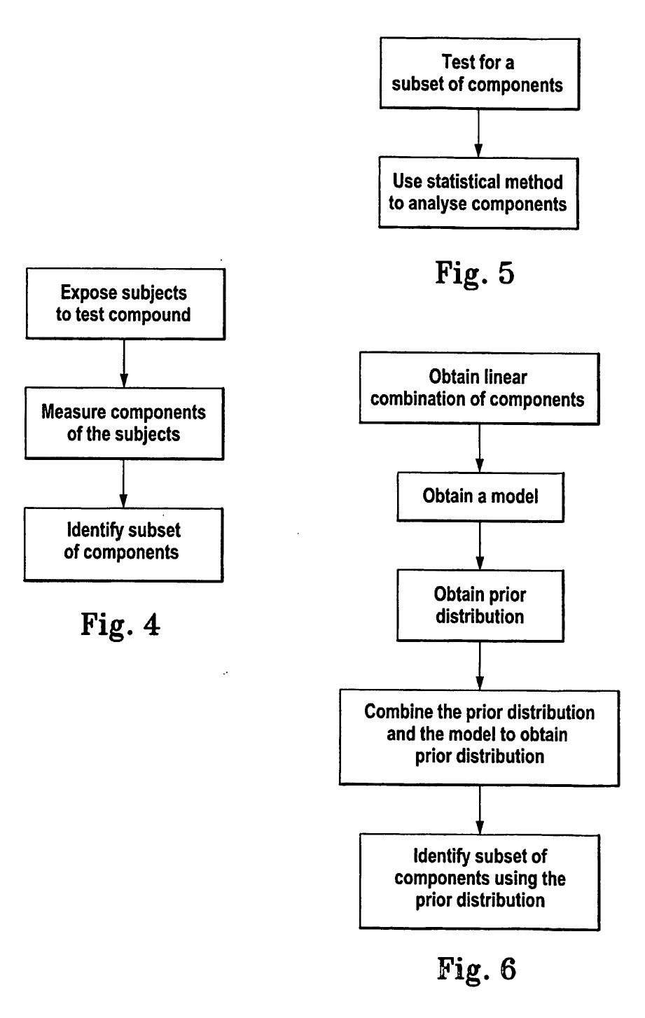

### DETAILED DESCRIPTION OF AN EMBODIMENT

The embodiment of the present invention identifies a relatively small number of components which can be used to identify whether a particular training sample has a feature. The components are “diagnostic” of that feature, or enable discrimination between samples having a different feature.

The number of components selected by the method can be controlled by the choice of parameters in the hyperprior. It is noted that the hyperprior is a gamma distribution with a specified shape and scale parameter. Essentially, from all the data which is generated from the system, the method of the present invention enables identification of a relatively small number of components which can be used to test for a particular feature. Once those components have been identified by this method, the components can be used in future to assess new samples. The method of the present invention utilises a statistical method to eliminate components that are not required to correctly predict the feature.

The inventors have found that component weightings of a linear combination of components of data generated from the training samples can be estimated in such a way as to eliminate the components that are not required to correctly predict the feature of the training sample. The result is that a subset of components are identified which can correctly predict the feature of the training sample. The method of the present invention thus permits identification from a large amount of data a relatively small and controllable number of components which are capable of correctly predicting a feature.

The method of the present invention also has the advantage that it requires usage of less computer memory than prior art methods. Accordingly, the method of the present invention can be performed rapidly on computers such as, for example, laptop machines. By using less memory, the method of the present invention also allows the method to be performed more quickly than other methods which use joint (rather than marginal) information on components for analysis of, for example, biological data.

The method of the present invention also has the advantage that it uses joint rather than marginal information on components for analysis.

A first embodiment relating to a multiclass logistic regression model will now be described.

A. Multi Class Logistic Regression Model

The method of this embodiment utilises the training samples in order to identify a subset of components which can classify the training samples into pre-defined groups. Subsequently, knowledge of the subset of components can be used for tests, for example clinical tests, to classify samples into groups such as disease classes. For example, a subset of components of a DNA microarray may be used to group clinical samples into clinically relevant classes such as, for example, healthy or diseased.

In this way, the present invention identifies preferably a small and controllable number of components which can be used to identify whether a particular training sample belongs to a particular group. The selected components are “diagnostic” of that group, or enable discrimination between groups. Essentially, from all the data which is generated from the system, the method of the present invention enables identification of a small number of components which can be used to test for a particular group. Once those components have been identified by this method, the components can be used in future to classify new samples into the groups. The method of the present invention preferably utilises a statistical method to eliminate components that are not required to correctly identify the group the sample belongs to.

The samples are grouped into sample groups (or “classes”) based on a pre-determined classification. The classification may be any desired classification by which the training samples are to be grouped. For example, the classification may be whether the training samples are from a leukemia cell or a healthy cell, or that the training samples are obtained from the blood of patients having or not having a certain condition, or that the training samples are from a cell from one of several types of cancer as compared to a normal cell.

In one embodiment, the input data is organised into an n x p data matrix X=(xᵢⱼ) with n training samples and p components. Typically, p will be much greater than n.

In another embodiment, data matrix X may be replaced by an n x n kernel matrix K to obtain smooth functions of X as predictors instead of linear predictors. An example of the kernel matrix K is kᵢⱼ=exp(−0.5*(xᵢ−xⱼ)^{t}(xᵢ−xⱼ)/σ²) where the subscript on x refers to a row number in the matrix X. Ideally, subsets of the columns of K are selected which give sparse representations of these smooth functions.

Associated with each sample class (group) may be a class label yᵢ, where yᵢ=k,kε{1, . . . ,G}, which indicates which of G sample classes a training sample belongs to. We write the n×1 vector with elements yᵢ as y. Given the vector {tilde under (y)} we can define indicator variables

$${e}_{ig} = \{ \begin{matrix}1 , & {y}_{i} = g \\ 0 , & otherwise\end{matrix} \qquad ( A1 )$$

In one embodiment, the component weights are estimated using a Bayesian statistical model (see Kotz and Johnson, 1983). Preferably, the weights are estimated by maximising the posterior distribution of the weights given the data generated from each training sample. This results in an objective function to be maximised consisting of two parts. The first part a likelihood function and the second a prior distribution for the weights which ensures that zero weights are preferred whenever possible. In a preferred embodiment, the likelihood function is derived from a multiclass logistic model. Preferably, the likelihood function is computed from the probabilities:

$$\begin{matrix}{p}_{ig} = \frac{{e}^{{x}_{i}^{T} {β}_{g}}}{( 1 + {\sum }_{h = 1}^{G - 1} {e}^{{x}_{i}^{T} {β}_{h}} )} , g = 1 , … , G - 1 \\ and & ( A2 ) \\ {p}_{iG} = \frac{1}{( 1 + {\sum }_{h = 1}^{G - 1} {e}^{{x}_{i}^{T} {β}_{h}} )} & ( A3 )\end{matrix}$$

wherein

P_{ig} is the probability that the training sample with input data Xᵢ will be in sample class g;

xᵢ^{T}β_{g} is a linear combination generated from input data from training sample i with component weights β_{g};

xᵢ^{T} is the components for the i^{th} Row of X and β_{g} is a set of component weights for sample class g;

Typically, as discussed above, the component weights are estimated in a manner which takes into account the apriori assumption that most of the component weights are zero.

In one embodiment, components weights βg in equation (A2) are estimated in a manner whereby most of the values are zero, yet the samples can still be accurately classified.

In one embodiment, the component weights are estimated by maximising the posterior distribution of the weights given the data in the Bayesian model referred to above.

Preferably, the component weights are estimated by

(a) specifying a hierarchical prior for the component weights β₁, . . . ,β_{G-1}; and

(b) specifying a likelihood function for the input data;

(c) determining the posterior distribution of the weights given the data using (A5); and

(d) determining component weights which maximise the posterior distribution.

In one embodiment, the hierarchical prior specified for the parameters β₁, . . . ,β_{G-1} is of the form:

$$P ( {β}_{1} … , {β}_{G - 1} ) = {\int }_{{τ}^{2}} {\prod }_{g = 1}^{G - 1} P ( {β}_{g} \vert {τ}_{g}^{2} ) P ( {τ}_{g}^{2} ) ⅆ {τ}^{2} \qquad ( A4 )$$

where β^{T}=(β₁^{T}, . . . ,β_{G-1}^{T}), τ^{T}=(τ₁^{T}, . . . ,τ_{G-1}^{T}), p(β_{g}|τ_{g}²) is N(0,diag{τ_{g}²}) and p(τ_{g}²) is a suitable prior.

In one embodiment,

$$p ( {τ}_{g}^{2} ) = {\prod }_{i = 1}^{n} p ( {τ}_{ig}^{2} )$$

where p(τ_{ig}²) is a prior wherein t_{ig}²=1/τ_{ig}² has an independent gamma distribution.

In another embodiment, p(τ_{ig}²) is a prior wherein τ_{ig}² has an independent gamma distribution.

In one embodiment, the likelihood function is L({tilde under (y)}|β₁, . . . ,β_{G-1}) of the form in equation (8) and the posterior distribution of β and {tilde under (τ)} given y is
p(βτ²|y)α L(y|β)p(β|τ²)p(τ²) (A5)

In one embodiment, the likelihood function has a first and second derivative.

In one embodiment, the first derivative is determined from the following algorithm:

$$\frac{\partial log L}{\partial βg} = {X}^{T} ( {e}_{∼ g} - {p}_{g} ) , g = 1 , … , G - 1 \qquad ( A6 )$$

wherein {tilde under (e)}_{g}^{T}=(e_{ig},i=1, . . . ,n), p_{g}^{T}=(p_{ig},i=1, . . . ,n) are vectors indicating membership of sample class g and probability of class g respectively.

In one embodiment, the second derivative is determined from the following algorithm:

$$\frac{{\partial }^{2} log L}{\partial {β}_{g} \partial {β}_{h}} = - {X}^{T} diag \{ {δ}_{hg} {p}_{g} - {p}_{h} {p}_{g} \} X \qquad ( A7 )$$

where δ_{hg} is 1 if h equals g and zero otherwise.

Equation A6 and equation A7 may be derived as follows:

(a) Using equations (A1), (A2) and (A3), the likelihood function of the data can be written as:

$$L = {\prod }_{i = 1}^{n} ( {\prod }_{g = 1}^{G - 1} {\{ \frac{{e}^{{x}_{i}^{T} {β}_{g}}}{( 1 + {\sum }_{g = 1}^{G - 1} {e}^{{x}_{i}^{T} {β}_{g}} )} \}}^{{e}_{ik}} {\{ \frac{1}{1 + {\sum }_{h = 1}^{G - 1} {e}^{{x}_{i}^{T} {β}_{h}}} \}}^{{e}_{iG}} ) \qquad ( A8 )$$

(b) Taking logs of equation (A6) and using the fact that

$${\sum }_{h = 1}^{G} {e}_{ih} = 1$$

for all i gives:

$$log L = {\sum }_{i = 1}^{n} ( {\sum }_{g = 1}^{G - 1} {e}_{ig} {x}_{i}^{T} {β}_{g} - log ( 1 + {\sum }_{g = 1}^{G - 1} {e}^{{x}_{i}^{T} {β}_{g}} ) ) \qquad ( A9 )$$

(c) Differentiating equation (A8) with respect to βg gives

$$\frac{\partial log L}{\partial βg} = {X}^{T} ( {{e}_{\sim}}_{g} - {p}_{g} ) , g = 1 , … , G - 1 \qquad ( A10 )$$

whereby {tilde under (e)}_{g}^{T}=(e_{ig},i=1,n), p_{g}^{T}=(p_{ig},i=1,n) are vectors indicating membership of sample class g and probability of class g respectively.

(d) The second derivative of equation (9) has elements

$$\frac{\partial log L}{\partial βg \partial {β}_{h}} = - {X}^{T} diag \{ {δ}_{hg} {p}_{g} - {p}_{h} {p}_{g} \} X \\ where \\ {δ}_{hg} = \{ \begin{matrix}1 , & h = g \\ 0 , & otherwise\end{matrix} \qquad ( A11 )$$

Component weights which maximise the posterior distribution of the likelihood function may be specified using an EM algorithm comprising an E step and an M step.

In conducting the EM algorithm, the E step preferably comprises the step computing a term of the form:

$$\begin{matrix}P = {\sum }_{g = 1}^{G - 1} {\sum }_{i = 1}^{n} E \{ {β}_{ig}^{2} / {τ}_{ig}^{2} \vert {\hat{β}}_{ig} \} \\ = {\sum }_{g = 1}^{G - 1} {\sum }_{i = 1}^{n} {β}_{ig}^{2} / {\hat{d}}_{ig}^{2}\end{matrix} \qquad ( A11a )$$

where \hat{d}_{ig}=E{1/τ_{ig}²|\hat{β}_{ig}}^{-0.5}, \hat{d}_{g}=(\hat{d}_{1g},\hat{d}_{2g}, . . . ,\hat{d}_{pg})^{T} and \hat{d}_{ig}=1/\hat{d}_{ig}=0 if \hat{β}_{ig}=0.

Preferably, equation (11a) is computed by calculating the conditional expected value of t_{ig}²=1/τ_{ig}² when p(β_{ig}|τ_{ig}²) is N(0,τ_{ig}²) and p(τ_{ig}²) has a specified prior distribution.

Explicit formulae for the conditional expectation will be presented later.

Typically, the EM algorithm comprises the steps:
(a) performing an E step by calculating the conditional expected value of the posterior distribution of component weights using the function:

$$Q = Q ( γ \vert y , \hat{γ} ) = log L - \frac{1}{2} {\sum }_{g = 1}^{G - 1} {γ}_{g}^{T} diag {\{ {d}_{g} ( {\hat{γ}}_{g} ) \}}^{- 2} {γ}_{g} \qquad ( A12 )$$
where xᵢ^{T}β_{g}=xᵢ^{T}P_{g}γ_{g} in equation (8), d(\hat{γ}_{g})=P_{g}^{T}\hat{d}_{g}, and \hat{d}_{g} is defined as in equation (11a) evaluated at \ddot{β}_{g}=P_{g}\hat{γ}_{g}. Here P_{g} is a matrix of zeroes and ones derived from the identity matrix such that P_{g}^{T}β_{g} selects non-zero elements of β_{g} which are denoted by γ_{g}.
(b) performing an M step by applying an iterative procedure to maximise Q as a function of γ whereby:

$${γ}^{t + 1} = {γ}^{t} - {{α}^{t} ( \frac{{\partial }^{2} Q}{\partial {γ}^{2}} )}^{- 1} ( \frac{\partial Q}{\partial γ} ) \qquad ( A13 )$$

where α^{t} is a step length such that 0≦α^{t}≦1; and γ=(γ_{g}, g=1, . . . , G-1).

Equation (A12) may be derived as follows:

Calculate the conditional expected value of (A5) given the observed data y and a set of parameter estimates \hat{β}.
Q=Q(β|{tilde under (y)},\hat{β})=E{ log p({tilde under (β)},τ|y)|y,\hat{β})

Consider the case when components of β (and \hat{β}) are set to zero i.e. for g=1, . . . , G-1, β_{g}=P_{g}γ_{g} and \ddot{β}_{g}=P_{g}\hat{γ}_{g}.

Ignoring terms not involving γ and using (A4), (A5), (A9) we get:

$$Q = log L - \frac{1}{2} {\sum }_{g = 1}^{G - 1} {\sum }_{i = 1}^{n} E \{ \frac{{γ}_{ig}^{2}}{{τ}_{ig}^{2}} \vert y , {γ}_{∼}^{⋀} \} \\ \begin{matrix}Q = log L - \frac{1}{2} {\sum }_{g = 1}^{G - 1} {\sum }_{i = 1}^{n} {γ}_{ig}^{2} E \{ \frac{1}{{τ}_{ig}^{2}} \vert y , {γ}_{∼}^{⋀} \} \\ = log L - \frac{1}{2} {\sum }_{g = 1}^{G - 1} {γ}_{g}^{T} diag {\{ {d}_{g} ( {\hat{γ}}_{g} ) \}}^{- 2} {γ}_{g}\end{matrix} \qquad ( A14 )$$

where xᵢ^{T}β_{g}=xᵢ^{T}P_{g}\hat{γ}_{g} in (A8), d_{g}(\hat{γ}_{g})=P_{g}^{T}\hat{d}_{g} where \hat{d} is defined as in equation (A11a) evaluated at \ddot{β}_{g}=P_{g}\hat{γ}_{g}.

Note that the conditional expectation can be evaluated from first principles given (A4). Some explicit expressions are given later.

The iterative procedure may be derived as follows: To obtain the derivatives required in (11), first note that from (A8), (A9) and (A10) writing d(\hat{γ})={d_{g}(\hat{γ}_{g}),g=1, . . . ,G-1}, we get

$$\begin{matrix}\begin{matrix}\frac{\partial Q}{\partial γ} = ( \frac{\partial β}{\partial γ} ) \frac{\partial log L}{\partial β} - diag {\{ d ( \hat{γ} ) \}}^{- 2} γ \\ = [ \begin{matrix}{X}_{1}^{T} ( {e}_{1} - {p}_{1} ) \\ ⋮ \\ {X}_{G - 1}^{T} ( {e}_{G - 1} - {p}_{G - 1} )\end{matrix} ] - diag {\{ d ( {γ}_{∼}^{⋀} ) \}}^{- 2} γ\end{matrix} \\ and & ( A15 ) \\ \begin{matrix}\frac{{\partial }^{2} Q}{\partial {{γ}_{∼}}^{2}} = ( \frac{\partial β}{\partial γ} ) \frac{{\partial }^{2} log L}{{\partial }_{β}^{2}} {( \frac{\partial β}{\partial γ} )}^{T} - diag {\{ d ( \hat{γ} ) \}}^{- 2} \\ = - \{ ( \begin{matrix}{X}_{1}^{T} {Δ}_{11} {X}_{1} & ⋯ & {X}_{1}^{T} {Δ}_{1 G - 1} {X}_{G - 1} \\ ⋮ & & ⋮ \\ {X}_{G - 1} {Δ}_{G - 11} {X}_{1} & & {X}_{G - 1} {Δ}_{G - 1 G - 11} {X}_{G - 1}\end{matrix} ) + diag {\{ d ( \hat{γ} ) \}}^{- 2} \}\end{matrix} \\ where & ( A16 ) \\ {Δ}_{gh} = diag \{ {δ}_{gh} {p}_{g} - {p}_{g} {p}_{h} \} , \\ {δ}_{gh} = \{ \begin{matrix}1 , & g = h \\ 0 , & otherwise\end{matrix} \\ d ( \hat{γ} ) = ( d ( {\hat{γ}}_{g} ) , g = 1 , … , G - 1 ) \\ and \\ {X}_{g}^{T} = {P}_{g}^{T} {X}^{T} , g = 1 , … G - 1 & ( A17 )\end{matrix}$$

In a preferred embodiment, the iterative procedure may be simplified by using only the block diagonals of equation (A16) in equation (A13). For g=1, . . . ,G-1, this gives:

$${γ}_{g}^{t + 1} = {γ}_{g}^{t} + {α}^{t} {\{ {X}_{g}^{T} {Δ}_{gg} {X}_{g} + diag {\{ {d}_{g} ( {\hat{γ}}_{g} ) \}}^{- 2} \}}^{- 1} \{ {X}_{g}^{T} ( {e}_{g} - {p}_{g} ) - diag \{ {d}_{g} ( {\hat{γ}}_{g} ) \} {γ}_{g}^{t} \} - \qquad ( A18 )$$

Rearranging equation (A18) leads to

$${γ}_{g}^{t + 1} = {γ}_{g}^{t} + {α}^{t} diag \{ {d}_{g} ( {\hat{γ}}_{g} ) \} {( {Y}_{g}^{T} {Δ}_{gg} {Y}_{g} + I )}^{- 1} {\{ {Y}_{g}^{T} ( {e}_{g} - {p}_{g} ) - diag {\{ {d}_{g} ( {\hat{γ}}_{g} ) \}}^{- 1} {γ}_{g}^{t} \}}^{- 1} \qquad ( A19 )$$

where
Y_{g}^{T}=diag{d_{g}(\hat{γ}_{g})}X_{g}^{T}

Writing p(g) for the number of columns of Y_{g}, (A19) requires the inversion of a p(g)×p(g) matrix which may be quite large. This can be reduced to an n×n matrix for p(g)>n by noting that:

$$\begin{matrix}{( {Y}_{g}^{T} {Δ}_{gg} {Y}_{g} + I )}^{- 1} = I - {{Y}_{g}^{t} ( {Y}_{g} {Y}_{g}^{T} + {Δ}_{gg}^{- 1} )}^{- 1} {Y}_{g} \\ = I - {{Z}_{g}^{T} ( {Z}_{g} {Z}_{g}^{T} + {I}_{n} )}^{- 1} {Z}_{g}\end{matrix} \qquad ( A20 )$$

where Z_{g}=Δ_{gg}²Y_{g}. Preferably, (A19) is used when p(g)>n and (A19) with (A20) substituted into equation (A19) is used when p(g)≦n.

Note that when τ_{ig}² has a Jeffreys prior we have:
E{t_{ig}²|\hat{β}_{ig}}=1/\hat{β}_{ig}²

In one embodiment, t_{ig}²=1/τ_{ig}² has an independent gamma distribution with scale parameter b>0 and shape parameter k>0 so that the density of t_{ig}² is:
γ(t_{ig}²,b,k)=b⁻¹(t_{ig}²/b)^{k-1} exp(−t_{ig}²/b)/Γ(k)

Omitting subscripts to simplify the notation, it can be shown that
E{t²|β}=(2k+1)/(2/b+β²) (A21)
as follows:

Define

$$I ( p , b , k ) = {\int }_{0}^{∞} {( {t}^{2} )}^{p} t exp ( - 0.5 {β}^{2} {t}^{2} ) γ ( {t}^{2} , b , k ) ⅆ {t}^{2}$$

then
I(p,b,k)=b^{p+0.5}{Γ(p+k+0.5)/Γ(k)}(1+0.5bβ²)^{-(p+k+0.5)}
Proof

Let s=β²/2 then

$$I ( p , b , k ) = {b}^{p + 0.5} {\int }_{0}^{∞} {( {t}^{2} / b )}^{p + 0.5} exp ( - s {t}^{2} ) γ ( {t}^{2} , b , k ) ⅆ {t}^{2}$$

Now using the substitution u=t²/b we get

$$I ( p , b , k ) = {b}^{p + 0.5} {\int }_{0}^{∞} {( u )}^{p + 0.5} exp ( - s u b ) γ ( u , l , k ) ⅆ u$$

Now let s′=bs and substitute the expression for γ(u,1,k). This gives

$$I ( p , b , k ) = {b}^{p + 0.5} {\int }_{0}^{∞} exp ( - ( {s}^{′} + 1 ) u ) {u}^{p + k + 0.5 - 1} ⅆ u / Γ ( k )$$

Looking up a table of Laplace transforms, eg Abramowitz and Stegun, then gives the result.

The conditional expectation follows from

$$\begin{matrix}E \{ {t}^{2} \vert β \} = I ( l , b , k ) / I ( 0 , b , k ) \\ = ( 2 k + 1 ) / ( 2 / b + {β}^{2} )\end{matrix}$$

As k tends to zero and b tends to infinity we get the equivalent result using Jeffreys prior. For example, for k=0.005 and b=2*10⁵
E{t²|β}=(1.01)/(10⁻⁵+β²)

Hence we can get arbitrarily close to the Jeffreys prior with this proper prior.

The algorithm for this model has

$$\begin{matrix}\hat{d} = E {\{ {t}^{2} \vert \hat{β} \}}^{- 0.5} \\ = E {\{ \frac{1}{{τ}^{2}} \vert \hat{β} \}}^{- 0.5}\end{matrix}$$

where the expectation is calculated as above.

In another embodiment, τ_{ig}² has an independent gamma distribution with scale parameter b>0 and shape parameter k>0. It can be shown that

$$\begin{matrix}E \{ {τ}_{ig}^{- 2} \vert {β}_{ig} \} = \frac{{\int }_{0}^{∞} {u}^{k - 3 / 2 - 1} exp ( - ( {γ}_{ig} / u + u ) ) ⅆ u}{b {\int }_{0}^{∞} {u}^{k - 1 / 2 - 1} exp ( - ( {γ}_{ig} / u + u ) ) ⅆ u} \\ = \sqrt{\frac{2}{b}} \frac{1}{\vert {β}_{ig} \vert} \frac{{K}_{3 / 2 - k} ( 2 \sqrt{{γ}_{ig}} )}{{K}_{1 / 2 - k} ( 2 \sqrt{{γ}_{ig}} )} \\ = \frac{1}{{\vert {β}_{ig} \vert}^{2}} \frac{( 2 \sqrt{{γ}_{ig}} ) {K}_{3 / 2 - k} ( 2 \sqrt{{γ}_{ig}} )}{{K}_{1 / 2 - k} ( 2 \sqrt{{γ}_{ig}} )}\end{matrix} \qquad ( A22 )$$

where γ_{ig}=β_{ig}²/2b and K denotes a modified Bessel function. For k=1 in equation (A22)
E{τ_{ig}⁻²|β}=√2/b(1/|β_{ig}|)

For K=0.5 in equation (A22)
E{τ_{ig}⁻²|β_{ig}}=√2/b(1/|β_{ig}|){K₁(2√γ_{ig})/K₀(2√γ_{ig})}
or equivalently
E{τ_{ig}⁻²|βᵢ}=(1/|β_{ig}|²){2√γᵢK₁(2√γ_{ig})K₀(2√γ_{ig})}
Proof of (A.1)

From the definition of the conditional expectation, writing γ=β²/2b, we get

$$E \{ {τ}^{- 2} \vert β \} = \frac{{\int }_{0}^{∞} {τ}^{- 2} {τ}^{- 1} exp ( - {γτ}^{- 2} ) {{b}^{- 1} ( {τ}^{- 2} / b )}^{k - 1} exp ( {τ}^{- 2} / b ) ⅆ {τ}^{2}}{{\int }_{0}^{∞} {τ}^{- 1} exp ( - {γτ}^{- 2} ) {{b}^{- 1} ( {τ}^{- 2} / b )}^{k - 1} exp ( {τ}^{- 2} / b ) ⅆ {τ}^{2}}$$

Rearranging, simplifying and making the substitution u=τ²/b gives the first equation in (A22).

The integrals in (22) can be evaluated by using the result

$${\int }_{0}^{∞} {x}^{- b - 1} exp [ - ( x + \frac{{a}^{2}}{x} ) ] ⅆ x = \frac{2}{{a}^{b}} {K}_{b} ( 2 a )$$

where K denotes a modified Bessel function, see Watson(1966).

Examples of members of this class are k=1 in which case
E{τ_{ig}⁻²|β_{ig}}=\sqrt{2/b}(1/|β_{ig}|)
which corresponds to the prior used in the Lasso technique, Tibshirani (1996). See also Figueiredo (2001).

The case k=0.5 gives
E{τ_{ig}⁻²|β_{ig}}=\sqrt{2/b}(1|/β_{ig}|){K₁(2\sqrt{γ_{ig}})/K₀(2\sqrt{γ_{ig}})}
or equivalently
E{τ_{ig}⁻²|β_{ig}}=(1/|β_{ig}|²){2\sqrt{γᵢ}K₁(2\sqrt{γ_{ig}})/K₀(2\sqrt{γ_{ig}})}
where K₀ and K₁ are modified Bessel functions, see Abramowitz and Stegun (1970). Polynomial approximations for evaluating these Bessel functions can be found in Abramowitz and Stegun (1970,p 379). The expressions above demonstrate the connection with the Lasso model and the Jeffreys prior model.

It will be appreciated by those skilled in the art that as k tends to zero and b tends to infinity the prior tends to a Jeffreys improper prior.

In one embodiment, the priors with 0<k≦1 and b>0 form a class of priors which might be interpreted as penalising non zero coefficients in a manner which is between the Lasso prior and the specification using Jeffreys hyper prior.

The hyperparameters b and k can be varied to control the number of components selected by the method. As k tends to zero for fixed b the number of components selected can be decreased and conversely as k tends to 1 the number of selected components can be increased.

In a preferred embodiment, the EM algorithm is performed as follows:
1. Set n=0 ,P_{g}=I and choose an initial value for \hat{γ}⁰. Choose a value for b and k in equation (A22). For example b=1e7 and k=0 gives the Jeffreys prior model to a good degree of approximation. This is done by ridge regression of log(p_{ig}/p_{iG}) on xᵢ where p_{ig} is chosen to be near one for observations in group g and a small quantity >0 otherwise—subject to the constraint of all probabilities summing to one.
2.Do the E step i.e. evaluate Q=Q(γ|y,\hat{γ}ⁿ). Note that this also depends on the values of k and b.
3. Set t=0. For g=1, . . . ,G-1 calculate:
   a) δ_{g}^{t}=γ_{g}^{t+1}−γ_{g}^{t} using (A19) with (A20) substituted into (A19) when p(g)≧n.
   (b) Writing δ^{t}=(δ_{g}^{t},g=1, . . . , G-1) Do a line search to find the value of α^{t} in {tilde under (γ)}^{t+1}={tilde under (γ)}^{t}+α^{t}{tilde under (δ)}^{t} which maximises (or simply increases) (12) as a function of α^{t}.
   c) set {tilde under (γ)}^{t+1}={tilde under (γ)}^{t} and t=t+1

Repeat steps (a) and (b) until convergence.

This produces γ*ⁿ⁺¹ say which maximises the current Q function as a function of γ.

For g=1, . . . ,G-1 determine

$${S}_{g} = \{ j \text{:} \vert {γ}_{jg}^{* n + 1} \vert \leq {ɛmax}_{k} \vert {γ}_{kg}^{* n + 1} \vert \}$$

Where ε<<1 , say 10⁻⁵. Define P_{g} so that β_{ig}=0 for i ∈S_{g} and
\hat{γ}_{g}ⁿ⁺¹={γ*_{jg}ⁿ⁺¹,j∉S_{g}}

This step eliminates variables with small coefficients from the model.
4.Set n=n+1 and go to 2 until convergence.

A second embodiment relating to an ordered cat logistic regression will now be described.

B. Ordered Categories Model

The method of this embodiment may utilise the training samples in order to identify a subset of components which can be used to determine whether a test sample belongs to a particular class. For example, to identify genes for assessing a tissue biopsy sample using microarray analysis, microarray data from a series of samples from tissue that has been previously ordered into classes of increasing or decreasing disease severity such as normal tissue, benign tissue, localised tumour and metastasised tumour tissue are used as training samples to identify a subset of components which is capable of indicating the severity of disease associated with the training samples. The subset of components can then be subsequently used to determine whether previously unclassified test samples can be classified as normal, benign, localised tumour or metastasised tumour. Thus, the subset of components is diagnostic of whether a test sample belongs to a particular class within an ordered set of classes. It will be apparent that once the subset of components have been identified, only the subset of components need be tested in future diagnostic procedures to determine to what ordered class a sample belongs.

The method of the invention is particularly suited for the analysis of very large amounts of data. Typically, large data sets obtained from test samples is highly variable and often differs significantly from that obtained from the training samples. The method of the present invention is able to identify subsets of components from a very large amount of data generated from training samples, and the subset of components identified by the method can then be used to classifying test samples even when the data generated from the test sample is highly variable compared to the data generated from training samples belonging to the same class. Thus, the method of the invention is able to identify a subset of components that are more likely to classify a sample correctly even when the data is of poor quality and/or there is high variability between samples of the same ordered class.

The components are “predictive” for that particular ordered class. Essentially, from all the data which is generated from the system, the method of the present invention enables identification of a relatively small number of components which can be used to classify the training data. Once those components have been identified by this method, the components can be used in future to classify test samples. The method of the present invention preferably utilises a statistical method to eliminate components that are not required to correctly classify the sample into a class that is a member of an ordered class.

In the following there are N samples, and vectors such as y, z and μ have components yᵢ, zᵢ and μᵢ for i=1, . . . , N. Vector multiplication and division is defined componentwise and diag{*} denotes a diagonal matrix whose diagonals are equal to the argument. We also use ∥*∥ to denote Euclidean norm.

Preferably, there are N observations y*ᵢ where y*ᵢ takes integer values 1, . . . ,G. The values denote classes which are ordered in some way such as for example severity of disease. Associated with each observation there is a set of covariates (variables, e.g gene expression values) arranged into a matrix X* with n row and p columns wherein n is the samples and p the components. The notation xᵢ*^{T} denotes the i^{th} row of X*. Individual (sample) i has probabilities of belonging to class k given by πᵢₖ=πₖ(xᵢ*).

Define cumulative probabilities

$${γ}_{ik} = {\sum }_{g = 1}^{k} {π}_{ik} , \\ k = 1 , … , G$$

Note that γᵢₖ is just the probability that observation i belongs to a class with index less than or equal to k. Let C be a N by p matrix with elements cᵢⱼ given by

$${c}_{ij} = \{ \begin{matrix}1 , & if observation i in class j \\ 0 , & otherwise\end{matrix}$$

and let R be an n by P matrix with elements rᵢⱼ given by

$${r}_{ij} = {\sum }_{g = 1}^{j} {c}_{ig}$$

These are the cumulative sums of the columns of C within rows.

For independent observations (samples) the likelihood of the data may be written as:

$$l = {\prod }_{i = 1}^{N} {\prod }_{k = 1}^{G - 1} {( \frac{{γ}_{ik}}{{γ}_{ik + 1}} )}^{{r}_{ik}} {( \frac{{γ}_{ik + 1} - {γ}_{ik}}{{γ}_{ik + 1}} )}^{{r}_{ik + 1} - {r}_{ik}}$$

and the log likelihood L may be written as:

$$L = {\sum }_{i = 1}^{N} {\sum }_{j = 1}^{G - 1} {r}_{ik} log ( \frac{{γ}_{ik}}{{γ}_{ik + 1}} ) + ( {r}_{ik + 1} - {r}_{ik} ) log ( \frac{{γ}_{ik + 1} - {γ}_{ik}}{{γ}_{ik + 1}} )$$

The continuation ratio model may be adopted here as follows:

$$log it ( \frac{{γ}_{ik + 1} - {γ}_{ik}}{{γ}_{ik + 1}} ) = log it ( \frac{{π}_{ik}}{{γ}_{ik + 1}} ) = {θ}_{k} + {x}_{i}^{T} {β}^{*}$$

for k=2, . . . ,G, see McCullagh and Nelder (1989) and McCullagh (1980) and the discussion therein. Note that

$$log it ( \frac{{γ}_{ik + 1} - {γ}_{ik}}{{γ}_{ik + 1}} ) = - log it ( \frac{{γ}_{ik}}{{γ}_{ik + 1}} ) .$$

The likelihood is equivalent to a logistic regression likelihood with response vector y and covariate matrix X
y=vec{R}
X=[B₁^{T}B₂^{T} . . . B_{N}^{T}]^{T}
Bᵢ=[I_{G-1}|1_{G-1}x*ᵢ^{T}]
where I_{G-1} is the G-1 by G-1 identity matrix and 1_{G-1} is a G-1 by 1 vector of ones.
Here vec{ } takes the matrix and forms a vector row by row.

Typically, as discussed above, the component weights are estimated in a manner which takes into account the a priori assumption that most of the component weights are zero.

Following Figueiredo (2001), in order to eliminate redundant variables (covariates), a prior is specified for the parameters β* by introducing a p×1 vector of hyperparameters.

Preferably, the prior specified for the component weights is of the form

$$p ( {β}^{*} ) = {\int }_{{τ}^{2}} p ( {β}^{*} \vert {v}^{2} ) p ( {v}^{2} ) ⅆ {v}^{2} \qquad ( B1 )$$

where p(β*|v²) is N(0,diag{v²}) and p(v²) is a suitably chosen hyperprior. For example,

$$p ( {v}^{2} ) α {\prod }_{i = 1}^{n} p ( {v}_{i}^{2} )$$

is a suitable form of Jeffreys prior.

In another embodiment, p(vᵢ²) is a prior wherein tᵢ²=1/vᵢ² has an independent gamma distribution.

In another embodiment, p(vᵢ²)is a prior wherein vᵢ² has an independent gamma distribution.

The elements of theta have a non informative prior.

Writing L({tilde under (y)}|β*θ) for the likelihood function, in a Bayesian framework the posterior distribution of β, θ and v given y is
p(β*φv|y)α L(y|β*φ)p(β*|v)p(v) (2)

By treating v as a vector of missing data, an iterative algorithm such as an EM algorithm (Dempster et al, 1977) can be used to maximise (2) to produce maximum a posteriori estimates of β and θ. The prior above is such that the maximum a posteriori estimates will tend to be sparse i.e. if a large number of parameters are redundant, many components of β* will be zero.

Preferably β^{T}=(θ^{T}β*^{T}in the following:

For the ordered categories model above it can be shown that

$$\begin{matrix}\frac{\partial L}{\partial β} = {X}^{t} ( y - μ ) & ( 11 ) \\ E \{ \frac{{\partial }^{2} L}{\partial {β}^{2}} \} = - {X}^{t} diag \{ μ ( 1 - μ ) \} X & ( 12 )\end{matrix}$$

Where μₗ=exp(xᵢ^{T}β)/(1+exp(xᵢ^{T}β)) and β^{T}=(θ₂, . . . ,θ_{G},β*^{T}).

The iterative procedure for maximising the posterior distribution of the components and component weights is an EM algorithm, such as, for example, that described in Dempster et al, 1977. Preferably, the EM algorithm is performed as follows:

1. Chose a hyperprior and values b and k for its parameters. Set n=0, S₀={1, 2, . . . , p }, φ⁽⁰⁾, and ε=10⁻⁵ (say). Set the regularisation parameter κ at a value much greater than 1, say 100. This corresponds to adding 1/κ² to the first G-1 diagonal elements of the second derivative matrix in the M step below.

If p≦N compute initial values β* by
β*=(X^{t}X+λI)⁻¹X^{T}g(y+ζ) (B2)
and if p>N compute initial values β* by

$${β}^{*} = \frac{1}{λ} ( I - {{X}^{T} ( {XX}^{T} + λ I )}^{- 1} X ) {X}^{T} g ( y + ζ ) \qquad ( B3 )$$

where the ridge parameter λ satisfies 0<λ≦1 and ζ is small and chosen so that the link function g(z)=log(z/(1−z)) is well defined at z=y+ζ.

2. Define

$${β}_{i}^{( n )} = \{ \begin{matrix}{β}_{i}^{*} , & i ε {S}_{n} \\ 0 , & otherwise\end{matrix}$$

and let Pₙ be a matrix of zeroes and ones such that the nonzero elements γ⁽ⁿ⁾ of β⁽ⁿ⁾ satisfy
γ⁽ⁿ⁾=Pₙ^{T}β⁽ⁿ⁾, β⁽ⁿ⁾=Pₙγ⁽ⁿ⁾
γ=Pₙ^{T}β, β=Pₙγ

Define w_{β}=(w_{βi},i=1,p), such that

$${w}_{βi} = \{ \begin{matrix}1 , & i \geq G \\ 0 , & otherwise\end{matrix}$$

and let w_{γ}=Pₙw_{β}

3. Perform the E step by calculating

$$\begin{matrix}Q ( β \text{\vert} {β}^{( n )} , {φ}^{( n )} ) = E \{ log p ( β , φ , v \text{\vert} y ) \vert y , {β}^{( n )} , {ϕ}^{( n )} \} \\ = L ( y \text{\vert} β , {ϕ}^{( n )} ) - 0.5 ( {‖ ( {β}^{*} {w}_{β} ) / {\hat{d}}^{( n )} ‖}^{2} )\end{matrix} \qquad ( 15 )$$

where L is the log likelihood function of y and \hat{d}_{ig}=E{1/τ_{ig}²|\hat{β}_{ig}}^{-0.5}, \hat{d}_{g}32 (\hat{d}_{1g}, \hat{d}_{2g}, . . . ,\hat{d}_{pg})^{T} and for convenience we define \hat{d}_{ig}=1/\hat{d}_{ig}=0 if \hat{β}_{ig}=0. Using β=Pₙγ and β⁽ⁿ⁾=Pₙγ⁽ⁿ⁾ (15) can be written as
Q(γ|γ⁽ⁿ⁾, φ⁽ⁿ⁾)=L(y|Pₙγ, φ⁽ⁿ⁾)−0.5(∥(γ*w_{γ})/d(γ⁽ⁿ⁾)∥²) (B4)
with d(γ⁽ⁿ⁾)=Pₙ^{T}d⁽ⁿ⁾ evaluated at β⁽ⁿ⁾=Pₙγ⁽ⁿ⁾.

4. Do the M step. This can be done with Newton Raphson iterations as follows. Set γ₀=γ⁽ⁿ⁾ and for r=0, 1, 2, . . . γᵣ₊₁=γᵣ+αᵣδᵣ where αᵣ is chosen by a line search algorithm to ensure Q(γᵣ₊₁|γ⁽ⁿ⁾, φ⁽ⁿ⁾)>Q(γᵣ|γ⁽ⁿ⁾, φ⁽ⁿ⁾).

For p≦N use

$${δ}_{r} = {Δ ( {d}^{*} ( {γ}^{( n )} ) ) [ {Y}_{n}^{T} {V}_{r}^{- 1} {Y}_{n} + I ]}^{- 1} ( {Y}_{n}^{T} {z}_{r} - \frac{{w}_{γ} {γ}_{r}}{{d}^{*} ( {γ}^{( n )} )} ) \qquad ( B5 )$$

where

$${d}^{*} ( {γ}^{( n )} ) = \{ \begin{matrix}d ( {γ}^{( n )} ) , & i \geq G \\ κ , & otherwise\end{matrix} \\ {Y}_{n}^{T} = Δ ( {d}^{*} ( {γ}^{( n )} ) ) {P}_{n}^{T} {X}^{T} \\ {V}_{r}^{- 1} = diag \{ {μ}_{r} ( 1 - {μ}_{r} ) \} \\ {z}_{r} = ( y - {μ}_{r} ) \\ and \\ {μ}_{r} = exp ( {XP}_{n} {γ}_{r} ) / ( 1 + exp ( {XP}_{n} {γ}_{r} ) ) .$$

For p>N use

$${δ}_{r} = Δ ( {d}^{*} ( {γ}^{( n )} ) ) [ I - {{Y}_{n}^{T} ( {Y}_{n} {Y}_{n}^{T} + {V}_{r} )}^{- 1} {Y}_{n} ] ( {Y}_{n}^{T} {z}_{r} - \frac{{w}_{γ} {γ}_{r}}{{d}^{*} ( {γ}^{( n )} )} ) \qquad ( B6 )$$

with Vᵣ and zᵣ defined as before.

Let γ* be the value of γᵣ when some convergence criterion is satisfied e.g
∥γᵣ−γᵣ₊₁∥<ε (for example 10⁻⁵).

5. Define β*=Pₙγ*,

$${S}_{n + 1} = \{ i \geq G \text{:} \vert {β}_{i} \vert > {max}_{j \geq G} ( {\vert {β}_{j} \vert}^{*} {ε}_{1} ) \}$$

where ε₁ is a small constant, say 1e−5. Set n=n+1.

6. Check convergence. If ∥γ*−γ⁽ⁿ⁾∥<ε₂ where ε₂ is suitably small then stop, else go to step 2 above.

Recovering the Probabilities

Once we have obtained estimates of the parameters β are obtained, calculate

$${a}_{ik} = \frac{{\hat{π}}_{ik}}{{\hat{γ}}_{ik}}$$

for i=1, . . . ,N and k=2, . . . ,G.

Preferably, to obtain the probabilities we use the recursion

$${π}_{iG} = {a}_{iG}$$

$${π}_{ik - 1} = ( \frac{{a}_{ik - 1}}{{a}_{ik}} ) ( 1 - {a}_{ik} ) {π}_{ik}$$

and the fact that the probabilities sum to one, for i=1, . . . ,N.

In one embodiment the covariate matrix X with rows xᵢ^{T} can be replaced by a matrix K with ij^{th} element kᵢⱼ and kᵢⱼ=κ(xᵢ−xⱼ) for some kernel function κ. This matrix can also be augmented with a vector of ones. Some example kernels are given in Table 1 below, see Evgeniou et al (1999).

TABLE 1
Examples of kernel functions

| Kernel function | Formula for κ(x − y) |
|---|---|
| Gaussian radial basis function | exp(−\|\|x − y\|\|²/a), a > 0 |
| Inverse multiquadric | (\|\|x − y\|\|² + c²)^{-1/2} |
| multiquadric | (\|\|x − y\|\|² + c²)^{1/2} |
| Thin plate splines | \|\|x − y\|\|²ⁿ⁺¹ |
| | \|\|x − y\|\|²ⁿln(\|\|x − y\|\|) |
| Multi layer perceptron | tanh(x · y − θ), for suitable θ |
| Ploynomial of degree d | (1 + x · y)^{d} |
| B splines | B₂ₙ₊₁(x − y) |
| Trigonometric polynomials | sin((d + 1/2)(x − y))/sin((x − y)/ |
| | 2) |

In Table 1 the last two kernels are preferably one dimensional i.e. for the case when X has only one column. Multivariate versions can be derived from products of these kernel functions. The definition of B₂ₙ₊₁ can be found in De Boor (1978). Use of a kernel function results in mean values which are smooth (as opposed to transforms of linear) functions of the covariates X. Such models may give a substantially better fit to the data.

A third embodiment relating to generalised linear models will now be described.

C. Generalised Linear Models

The method of this embodiment utilises the training samples in order to identify a subset of components which can predict the characteristic of a sample. Subsequently, knowledge of the subset of components can be used for tests, for example clinical tests to predict unknown values of the characteristic of interest. For example, a subset of components of a DNA microarray may be used to predict a clinically relevant characteristic such as, for example, a blood glucose level, a white blood cell count, the size of a tumour, tumour growth rate or survival time.

In this way, the present invention identifies preferably a relatively small number of components which can be used to predict a characteristic for a particular sample. The selected components are “predictive” for that characteristic. By appropriate choice of hyperparameters in the hyper prior the algorithm can be made to select subsets of varying sizes. Essentially, from all the data which is generated from the system, the method of the present invention enables identification of a small number of components which can be used to predict a particular characteristic. Once those components have been identified by this method, the components can be used in future to predict the characteristic for new samples. The method of the present invention preferably utilises a statistical method to eliminate components that are not required to correctly predict the characteristic for the sample.

The inventors have found that component weights of a linear combination of components of data generated from the training samples can be estimated in such a way as to eliminate the components that are not required to predict a characteristic for a training sample. The result is that a subset of components are identified which can correctly predict the characteristic for samples in the training set. The method of the present invention thus permits identification from a large amount of data a relatively small number of components which are capable of correctly predicting a characteristic for a training sample, for example, a quantity of interest.

The characteristic may be any characteristic of interest. In one embodiment, the characteristic is a quantity or measure. In another embodiment, they may be the index number of a group, where the samples are grouped into two sample groups (or “classes”) based on a pre-determined classification. The classification may be any desired classification by which the training samples are to be grouped. For example, the classification may be whether the training samples are from a leukemia cell or a healthy cell, or that the training samples are obtained from the blood of patients having or not having a certain condition, or that the training samples are from a cell from one of several types of cancer as compared to a normal cell. In another embodiment the characteristic may be a censored survival time, indicating that particular patients have survived for at least a given number of days. In other embodiments the quantity may be any continuously variable characteristic of the sample which is capable of measurement, for example blood pressure.

In one embodiment, the data may be a quantity yᵢ, where iε{1, . . . , N}. We write the n×1 vector with elements yᵢ as y. We define a p×1 parameter vector β of component weights (many of which are expected to be zero), and a q×1 vector of parameters φ (not expected to be zero). Note that q could be zero (i.e. the set of parameters not expected to be zero may be empty).

In one embodiment, the input data is organised into an n×p data matrix X=(xᵢⱼ) with n test training samples and p components. Typically, p will be much greater than n.

In another embodiment, data matrix X may be replaced by an n×n kernel matrix K to obtain smooth functions of X as predictors instead of linear predictors. An example of the kernel matrix K is kᵢⱼ=exp(−0.5*(xᵢ−xⱼ)^{t}(xᵢ−xⱼ)/σ²) where the subscript on x refers to a row number in the matrix X. Ideally, subsets of the columns of K are selected which give sparse representations of these smooth functions.

Typically, as discussed above, the component weights are estimated in a manner which takes into account the apriori assumption that most of the component weights are zero.

In one embodiment, the prior specified for the component weights is of the form:

$$p ( β ) = {\int }_{{υ}^{2}}^{} p ( β \text{\vert} {v}^{2} ) p ( {v}^{2} ) ⅆ {v}^{2} \qquad ( C1 )$$

wherein v is a p×1 vector of hyperparameters, and where p(β|v²) is N(0, diag{v²}) and p(v²) is some hyperprior distribution for v².

A suitable form of hyperprior is,

$$p ( {v}^{2} ) α {\prod }_{i = 1}^{p} p ( {v}_{i}^{2} ) .$$

Jeffreys

In another embodiment, the hyperprior p(v²) is such that each tᵢ²=1/vᵢ² has an independent gamma distribution.

In another embodiment, the hyperprior p(v²) is such that each vᵢ² has an independent gamma distribution.

Preferably, an uninformative prior for φ is specified.

The likelihood function is defined from a model for the distribution of the data. Preferably, in general, the likelihood function is any suitable likelihood function. For example, the likelihood function L({tilde under (y)}|βφ) may be, but not restricted to, of the form appropriate for a generalised linear model (GLM), such as for example, that described by Nelder and Wedderburn (1972). Preferably, in this case, the likelihood function is of the form:

$$L = log p ( y \text{\vert} β , ϕ ) = {\sum }_{i = 1}^{N} \{ \frac{{y}_{i} {θ}_{i} - b ( {θ}_{i} )}{{a}_{i} ( ϕ )} + c ( {y}_{i} , ϕ ) \} \qquad ( C2 )$$

where y=(y₁, . . . , yₙ)^{T} and aᵢ(φ)=φ/wᵢ with the wᵢ being a fixed set of known weights and φ a single scale parameter.

Preferably, the likelihood function is specified as follows: We have
E{yᵢ}=b′(θᵢ)
Var{y}=b″(θᵢ)aᵢ(φ)=τᵢ²aᵢ(φ) (C3)

Each observation has a set of covariates xᵢ and a linear predictor ηᵢ=xᵢ^{T}β. The relationship between the mean of the i^{th} observation and its linear predictor is given by the link function ηᵢ=g(μᵢ)=g(b′(θᵢ) ). The inverse of the link is denoted by h, i.e.
μᵢ=b′(θᵢ)=h(ηᵢ).

In addition to the scale parameter, a generalised linear model may be specified by four components:
the likelihood or (scaled) deviance function,
the link function
the derivative of the link function
the variance function.

Some common examples of generalised linear models are given in the table below.

| | | Derivative | | |
|---|---|---|---|---|
| | Link function | of link | Variance | Scale |
| Distribution | g(μ) | function | function | parameter |
| Gaussian | μ | 1 | 1 | Yes |
| Binomial | log(μ/(1 − μ)) | 1/(μ(1 − μ)) | μ(1 − μ)/n | No |
| Poisson | log (μ) | 1/μ | μ | No |
| Gamma | 1/μ | −1/μ² | μ² | Yes |
| Inverse | 1/μ² | −2/μ³ | μ³ | Yes |
| Gaussian | | | | |

In another embodiment, a quasi likelihood model is specified wherein only the link function and variance function are defined. In some instances, such specification results in the models in the table above. In other instances, no distribution is specified.

In one embodiment, the posterior distribution of β φ and v given y is estimated using:
p(βφv|y)α L(y|βφ)p(β|v)p(v) (C4)
wherein L({tilde under (y)}|βφ) is the likelihood function.

In one embodiment, v may be treated as a vector of missing data and an iterative procedure used to maximise equation (C4) to produce maximum a posteriori estimates of β. The prior of equation (C1) is such that the maximum a posteriori estimates will tend to be sparse i.e. if a large number of parameters are redundant, many components of β will be zero.

As stated above, the component weights which maximise the posterior distribution may be determined using an iterative procedure. Preferable, the iterative procedure for maximising the posterior distribution of the components and component weights is an EM algorithm comprising an E step and an M step, such as, for example, that described in Dempster et al, 1977.

In conducting the EM algorithm, the E step preferably comprises the step of computing terms of the form

$$\begin{matrix}P = {\sum }_{i = 1}^{P} E \{ {β}_{i}^{2} / {v}_{i}^{2} \text{\vert} {\hat{β}}_{i} \} \\ = {\sum }_{i = 1}^{P} {β}_{i}^{2} / {\hat{d}}_{i}^{2}\end{matrix} \qquad ( C4a )$$

where \hat{d}ᵢ=dᵢ(\hat{β}ᵢ)=E{1/vᵢ²|\hat{β}ᵢ}^{-0.5} and for convenience we define \hat{d}ᵢ=1/\hat{d}ᵢ=0 if \hat{β}ᵢ=0. In the following we write \hat{d}=d(\hat{β})=(\hat{d}₁, \hat{d}₂, . . . ,\hat{d}ₙ)^{T}. In a similar manner we define for example d(β⁽ⁿ⁾) and d(γ⁽ⁿ⁾)=Pₙ^{T}d(Pₙγ⁽ⁿ⁾) where β⁽ⁿ⁾=Pₙγ⁽ⁿ⁾ and Pₙ is obtained from the p by p identity matrix by omitting columns j for which βⱼ⁽ⁿ⁾=0.

Preferably, equation (C4a) is computed by calculating the conditional expected value of tᵢ²=1/vᵢ² when p(βᵢ|vᵢ²) is N(0,vᵢ²) and p(vᵢ²)has a specified prior distribution. Specific examples and formulae will be given later.

In a general embodiment, appropriate for any suitable likelihood function, the EM algorithm comprises the steps:
(a) Selecting a hyperprior and values for its parameters. Initialising the algorithm by setting n=0, S₀={1, 2, . . . , p}, initialise φ⁽⁰⁾, β* and applying a value for ε, such as for example ε=10⁻⁵;
(b) Defining

$${β}_{i}^{( n )} = \{ \begin{matrix}{β}_{i}^{*} , & i ε {S}_{n} \\ 0 , & otherwise\end{matrix} \qquad ( C5 )$$

and let Pn be a matrix of zeroes and ones such that the nonzero elements γ⁽ⁿ⁾ of β⁽ⁿ⁾ satisfy
γ⁽ⁿ⁾=Pₙ^{T}β⁽ⁿ⁾, β⁽ⁿ⁾=Pₙγ⁽ⁿ⁾
γ=Pₙ^{T}β, β=Pₙγ
(c) performing an estimation (E) step by calculating the conditional expected value of the posterior distribution of component weights using the function:

$$\begin{matrix}Q ( β \text{\vert} {β}^{( n )} , {φ}^{( n )} ) = E \{ log p ( β , φ , v \text{\vert} y ) \vert y , {β}^{( n )} , {ϕ}^{( n )} \} \\ = L ( y \text{\vert} β , {ϕ}^{( n )} ) - 0.5 {β}^{T} {Δ ( d ( {β}^{( n )} ) )}^{- 2} β\end{matrix} \qquad ( C6 )$$

where L is the log likelihood function of y. Using β=Pₙγ and d(γ⁽ⁿ⁾) as defined in (C4a), (C6) can be written as
Q(γ|γ⁽ⁿ⁾, φ⁽ⁿ⁾)=L(y|Pₙγ, φ⁽ⁿ⁾)−0.5γ^{T}Δ(d(γ⁽ⁿ⁾))⁻²γ (C7)
(d) performing a maximisation (M) step by applying an iterative procedure to maximise Q as a function of γ whereby γ₀=γ⁽ⁿ⁾ and for r=0, 1, 2, γᵣ₊₁=γᵣ+αᵣδr and where αr is chosen by a line search algorithm to ensure

$$\begin{matrix}Q ( {γ}_{r + 1} \text{\vert} {γ}^{( n )} , {ϕ}^{( n )} ) > Q ( {γ}_{r} \text{\vert} {γ}^{( n )} , {ϕ}^{( n )} ) , and & \\ {δ}_{r} = {Δ ( d ( {γ}^{( n )} ) ) [ - Δ ( d ( {γ}^{( n )} ) ) \frac{{\partial }^{2} L}{{\partial }^{2} {γ}_{r}} Δ ( d ( {γ}^{( n )} ) ) + I ]}^{- 1} ( Δ ( d ( {γ}^{( n )} ) ) ( \frac{\partial L}{\partial {γ}_{r}} - \frac{{γ}_{r}}{d ( {γ}^{( n )} )} ) \\ where \text{:} & ( C8 ) \\ d ( {γ}^{( n )} ) = {P}_{n}^{T} d ( {P}_{n} {γ}^{( n )} ) as in ( C 4a ) ; \\ and \\ \frac{\partial L}{\partial {γ}_{r}} = {P}_{n}^{T} \frac{\partial L}{\partial {β}_{r}} , \frac{{\partial }^{2} L}{{\partial }^{2} {γ}_{r}} = {P}_{n}^{T} \frac{{\partial }^{2} L}{{\partial }^{2} {β}_{r}} {P}_{n} \\ for \\ {β}_{r} = {P}_{n} {γ}_{r} . & \end{matrix}$$
(e) Let γ* be the value of γr when some convergence criterion is satisfied, for example, ∥γr−γr+1∥<ε (for example 10⁻⁵);
(f) Defining β*=Pₙγ* , Sₙ₊₁={i:|βᵢ|>max(|βⱼ|*ε₁)}
   where ε₁ is a small constant, for example 1e−5.
(g) Set n=n+1 and choose φ⁽ⁿ⁺¹⁾=φ⁽ⁿ⁾+κₙ(φ*−φ⁽ⁿ⁾) where φ* satisfies

$$\frac{\partial }{\partial ϕ} L ( y \text{\vert} {P}_{n} {γ}^{*} , ϕ ) = 0$$

and κₙ is a damping factor such that 0<κₙ≦1; and
(h) Check convergence. If ∥γ*−γ⁽ⁿ⁾∥<ε₂ where ε₂ is suitably small then stop, else go to step (b) above.

In another embodiment, tᵢ²=1/vᵢ² has an independent gamma distribution with scale parameter b>0 and shape parameter k>0 so that the density of tᵢ² is
γ(tᵢ²,b,k)=b⁻¹(tᵢ²/b)^{k-1}exp(−tᵢ²/b)/Γ(k)

It can be shown that
E{t²|β}=(2k+1)/(2/b+β²)
as follows:

Define

$$I ( p , b , k ) = {\int }_{0}^{∞} {( {t}^{2} )}^{p} t exp ( - 0.5 {β}^{2} {t}^{2} ) γ ( {t}^{2} , b , k ) ⅆ {t}^{2}$$

$$then$$

$$I ( p , b , k ) = {b}^{p + 0.5} \{ Γ ( p + k + 0.5 ) / Γ ( k ) \} {( 1 + 0.5 b {β}^{2} )}^{- ( p + k + 0.5 )}$$

Proof

Let s=β²/2 then

$$I ( p , b , k ) = {b}^{p + 0.5} {\int }_{0}^{∞} {( {t}^{2} / b )}^{p + 0.5} exp ( - {st}^{2} ) γ ( {t}^{2} , b , k ) ⅆ {t}^{2}$$

Now using the substitution u=t²/b we get

$$I ( p , b , k ) = {b}^{p + 0.5} {\int }_{0}^{∞} {( u )}^{p + 0.5} exp ( - sub ) γ ( u , 1 , k ) ⅆ u$$

Now let s′=bs and substitute the expression for γ(u,l,k). This gives

$$I ( p , b , k ) = {b}^{p + 0.5} {\int }_{0}^{∞} exp ( - ( {s}^{′} + 1 ) u ) {u}^{p + 0.5 - 1} ⅆ u / Γ ( k )$$

Looking up a table of Laplace transforms, eg Abramowitz and Stegun, then gives the result.

The conditional expectation follows from

$$\begin{matrix}E \{ {t}^{2} \text{\vert} β ) = I ( 1 , b , k ) / I ( 0 , b , k ) \\ = ( 2 k + 1 ) / ( 2 / b + {β}^{2} )\end{matrix}$$

As k tends to zero and b tends to infinity we get the equivalent result using Jeffreys prior. For example, for k=0.005 and b=2*10⁵
E{t²|β}=(1.01)/(10⁻⁵+β²)

Hence we can get arbitrarily close to the algorithm with a Jeffreys hyperprior with this proper prior.

In another embodiment, vᵢ² has an independent gamma distribution with scale parameter b>0 and shape parameter k>0. It can be shown that

$$\begin{matrix}E \{ {v}_{i}^{- 2} \text{\vert} {β}_{i} \} = \frac{{\int }_{0}^{∞} {u}^{k - 3 / 2 - 1} exp ( - ( {λ}_{i} / u + u ) ) ⅆ u}{b {\int }_{0}^{∞} {u}^{k - 1 / 2 - 1} exp ( - ( {λ}_{i} / u + u ) ) ⅆ u} \\ = \sqrt{\frac{2}{b}} \frac{1}{\vert {β}_{i} \vert} \frac{{K}_{3 / 2 - k} ( 2 \sqrt{{λ}_{i}} )}{{K}_{1 / 2 - k} ( 2 \sqrt{{λ}_{i}} )} \\ = \frac{1}{{\vert {β}_{i} \vert}^{2}} \frac{( 2 \sqrt{{λ}_{i}} ) {K}_{3 / 2 - k} ( 2 \sqrt{{λ}_{i}} )}{{K}_{1 / 2 - k} ( 2 \sqrt{{λ}_{i}} )}\end{matrix} \qquad ( C9 )$$

where λ₁=βᵢ²/2b and K denotes a modified Bessel function, which can be shown as follows:

For k=1 in equation (c9)
E{vᵢ⁻²|βᵢ}=\sqrt{2/b}(1/|βᵢ|)

For K=0.5 in equation (C9)
E{vᵢ⁻²|βᵢ}=\sqrt{2/b}(1/|βᵢ|){K₁(2\sqrt{λᵢ})/K₀(2\sqrt{λᵢ})}
or equivalently
E{vᵢ⁻²|βᵢ}=(1/|βᵢ|²){2\sqrt{λᵢ}Kᵢ(2\sqrt{λᵢ})/K₀(2\sqrt{λᵢ})}

Proof

From the definition of the conditional expectation, writing λᵢ=βᵢ²/2b, we get

$$E \{ {v}_{i}^{- 2} \text{\vert} {β}_{i} \} = \frac{{\int }_{0}^{∞} {v}_{i}^{- 2} {v}_{i}^{- 1} exp ( - {λ}_{i} {v}_{i}^{- 2} ) {{b}^{- 1} ( {v}_{i}^{- 2} / b )}^{k - 1} exp ( {v}_{i}^{- 2} / b ) ⅆ {v}_{i}^{2}}{{\int }_{0}^{∞} {v}_{i}^{- 1} exp ( - {λ}_{i} {v}_{i}^{- 2} ) {{b}^{- 1} ( {v}_{i}^{- 2} / b )}^{k - 1} exp ( {v}_{i}^{- 2} / b ) ⅆ {v}_{i}^{2}}$$

Rearranging, simplifying and making the substitution u=vᵢ²/b gives A.1

The integrals in A.1 can be evaluated by using the result

$${\int }_{0}^{∞} {x}^{- b - 1} exp [ - ( x + \frac{{a}^{2}}{x} ) ] ⅆ x = \frac{2}{{a}^{b}} {K}_{b} ( 2 a )$$

where K denotes a modified Bessel function, see Watson(1966).

Examples of members of this class are k=1 in which case
E{vᵢ⁻²|βᵢ}=\sqrt{2/b}(1/|βᵢ|)
which corresponds to the prior used in the Lasso technique, Tibshirani (1996). See also Figueiredo (2001).

The case k=0.5 gives
E{vᵢ⁻²|βᵢ}=\sqrt{2/b}(1/|βᵢ|){K₁(2\sqrt{λᵢ})/K₀(2\sqrt{λᵢ})}
or equivalently
E{vᵢ⁻²|βᵢ}=(1/|βᵢ|²){2\sqrt{λᵢ}K₁(2\sqrt{λᵢ})/K₀(2\sqrt{λᵢ})}
where K₀ and K₁ are modified Bessel functions, see Abramowitz and Stegun (1970). Polynomial approximations for evaluating these Bessel functions can be found in Abramowitz and Stegun (1970, p 379). Details of the above calculations are given in the Appendix.

The expressions above demonstrate the connection with the Lasso model and the Jeffreys prior model.

It will be appreciated by those skilled in the art that as k tends to zero and b tends to infinity the prior tends to a Jeffreys improper prior.

In one embodiment, the priors with 0<k≦1 and b>0 form a class of priors which might be interpreted as penalising non zero coefficients in a manner which is between the Lasso prior and the original specification using Jeffreys prior.

In another embodiment, in the case of generalised linear models, step (d) in the maximisation step may be estimated by replacing

$$\frac{{\partial }^{2} L}{{\partial }^{2} {γ}_{r}}$$

with its expectation

$$E \{ \frac{{\partial }^{2} L}{{\partial }^{2} {γ}_{r}} \} .$$

This is preferred when the model of the data is a generalised linear model.

For generalised linear models the expected value

$$E \{ \frac{{\partial }^{2} L}{{\partial }^{2} {γ}_{r}} \}$$

may be calculated as follows. Beginning with

$$\frac{\partial L}{\partial β} = {X}^{T} \{ Δ ( \frac{1}{{τ}_{i}^{2}} \frac{\partial {μ}_{i}}{\partial {η}_{i}} ) ( \frac{{y}_{i} - {μ}_{i}}{{a}_{i} ( ϕ )} ) \} \qquad ( C10 )$$

where X is the N by p matrix with i^{th} row xᵢ^{T} and

$$E \{ \frac{{\partial }^{2} L}{{\partial }^{2} {β}^{2}} \} = - E \{ ( \frac{\partial L}{\partial β} ) {( \frac{\partial L}{\partial β} )}^{T} \} \\ we get \\ E \{ \frac{{\partial }^{2} L}{{\partial }^{2} {β}^{2}} \} = - {X}^{T} {Δ ( {a}_{i} ( φ ) {{τ}_{i}^{2} ( \frac{\partial {η}_{i}}{\partial {μ}_{i}} )}^{2} )}^{- 1} X \qquad ( C11 )$$

Equations (C10) and (C11) can be written as

$$\begin{matrix}\frac{\partial L}{\partial β} = {X}^{T} {V}^{- 1} ( \frac{\partial η}{\partial μ} ) ( y - μ ) & ( C12 ) \\ E \{ \frac{{\partial }^{2} L}{\partial {β}^{2}} \} = - {X}^{t} {V}^{- 1} X \\ where \\ V = Δ ( {a}_{i} ( φ ) {{τ}_{i}^{2} ( \frac{\partial {η}_{i}}{\partial {μ}_{i}} )}^{2} ) . & ( C13 )\end{matrix}$$

Preferably, for generalised linear models, the EM algorithm comprises the steps:
(a) Choose a hyper prior and its parameters. Initialising the algorithm by setting n=0, S₀={1, 2, . . . , p}, φ⁽⁰⁾, applying a value for ε, such as for example ε=10⁻⁵, and
If p≦N compute initial values β* by
   β*=(X^{t}X+λI)⁻¹X^{T}g(y+ζ) (C14)
and if p>N compute initial values β* by

$${β}^{*} = \frac{1}{λ} ( I - {{X}^{T} ( {XX}^{T} + λ I )}^{- 1} X ) {X}^{T} g ( y + ζ ) \qquad ( C15 )$$
where the ridge parameter λ satisfies 0<λ≦1 and ζ is small and chosen so that the link function is well defined at y+ζ.
(b) Defining

$${β}_{i}^{( n )} = \{ \begin{matrix}{β}_{i}^{*} , & i ε {S}_{n} \\ 0 , & otherwise\end{matrix}$$

and let Pn be a matrix of zeroes and ones such that the nonzero elements γ(n) of β(n) satisfy
   γ⁽ⁿ⁾=Pₙ^{T}β⁽ⁿ⁾, β⁽ⁿ⁾=Pₙγ⁽ⁿ⁾
   γ=Pₙ^{T}γ, β=Pₙγ
(c) performing an estimation (E) step by calculating the conditional expected value of the posterior distribution of component weights using the function:

$$\begin{matrix}Q ( β \text{\vert} {β}^{( n )} , {φ}^{( n )} ) = E \{ log p ( β , φ , v \vert y ) \vert y , {β}^{( n )} , {φ}^{( n )} \} \\ = L ( y \text{\vert} β , {ϕ}^{( n )} ) - 0.5 {β}^{T} {Δ ( d ( {β}^{( n )} ) )}^{- 2} β\end{matrix} \qquad ( C16 )$$
where L is the log likelihood function of y. Using β=Pₙγ and β⁽ⁿ⁾=Pₙγ⁽ⁿ⁾ (C16) can be written as
   Q(γ|γ⁽ⁿ⁾,φ⁽ⁿ⁾)=L(y|Pₙγ,φ⁽ⁿ⁾)−0.5γ^{T}Δ(d(γ⁽ⁿ⁾))⁻²γ (C17)
(d) performing a maximisation (M) step by applying an iterative procedure, for example a Newton Raphson iteration, to maximise Q as a function of γ whereby γ₀=γ⁽ⁿ⁾ and for r=0, 1, 2, . . . γᵣ₊₁=γᵣ+αᵣ δᵣ where αᵣ is chosen by a line search algorithm to ensure Q(γᵣ₊₁|γ⁽ⁿ⁾,φ⁽ⁿ⁾)>Q(γᵣ|γ⁽ⁿ⁾,φ⁽ⁿ⁾), and for
p≧N use

$${δ}_{r} = {Δ ( d ( {γ}^{( n )} ) ) [ {Y}_{n}^{T} {V}_{r}^{- 1} {Y}_{n} + I ]}^{- 1} ( {Y}_{n}^{T} {V}_{r}^{- 1} {z}_{r} - \frac{{γ}_{r}}{d ( {γ}^{( n )} )} ) \\ where \\ {Y}_{n} = Δ ( d ( {γ}^{( n )} ) ) {P}_{n}^{T} X \\ V = Δ ( {a}_{i} ( φ ) {{τ}_{i}^{2} ( \frac{\partial {η}_{i}}{\partial {μ}_{i}} )}^{2} ) \\ z = \frac{\partial η}{\partial μ} ( y - μ ) \qquad ( C18 )$$
and the subscript r denotes that these quantities are evaluated at μ=h(XPₙγᵣ).

For p>N use

$${δ}_{r} = Δ ( d ( {γ}^{( n )} ) ) [ I - {{Y}_{n}^{T} ( {Y}_{n} {Y}_{n}^{T} + {V}_{r} )}^{- 1} {Y}_{n} ] ( {Y}_{n}^{T} {V}_{r}^{- 1} {z}_{r} - \frac{{γ}_{r}}{d ( {γ}^{( n )} )} ) \qquad ( C19 )$$

with Vᵣ and zᵣ defined as before.
(e) Let γ* be the value of γᵣ when some convergence criterion is satisfied e.g
   ∥γᵣ−γᵣ₊₁∥<ε (for example 10⁻⁵).
(f) Define β*=Pₙγ* , Sₙ₊₁={i: |βᵢ|>(|βⱼ|*εₗ)} where ε₁ is a small constant, say 1e-5. Set n=n+1 and choose φⁿ⁺¹=φⁿ+κₙ(φ*−φⁿ) where φ* satisfies

$$\frac{\partial }{\partial ϕ} L ( y \text{\vert} {P}_{n} {γ}^{*} , ϕ ) = 0$$

and κₙ is a damping factor such that 0<κₙ≦1. Note that in some cases the scale parameter is known or this equation can be solve explicitly to get an updating equation for φ.

The above embodiments may be extended to incorporate quasi likelihood methods Wedderburn (1974) and McCullagh and Nelder (1983)). In such an embodiment, the same iterative procedure as detailed above will be appropriate, but with L replaced by a quasi likelihood as shown above and, for example, Table 8.1 in McCullagh and Nelder (1983). In one embodiment there is a modified updating method for the scale parameter φ. To define these models requires specification of the variance function τ², the link function g and the derivative of the link function ∂η/∂μ. Once these are defined the above algorithm can be applied.

In one embodiment for quasi likelihood models, step 5 of the above algorithm is modified so that the scale parameter is updated by calculating

$${ϕ}^{( n + 1 )} = \frac{1}{N} {\sum }_{i = 1}^{N} \frac{{( {y}_{i} - {μ}_{i} )}^{2}}{{τ}_{i}^{2}}$$

where μ and τ are evaluated at β*=Pₙγ*. Preferably, this updating is performed when the number of parameters s in the model is less than N. A divisor of N −s can be used when s is much less than N.

In another embodiment, for both generalised linear models and Quasi likelihood models the covariate matrix X with rows xᵢ^{T} can be replaced by a matrix K with ij^{th} element kᵢⱼ and kᵢⱼ=κ(xᵢ−xⱼ) for some kernel function κ. This matrix can also be augmented with a vector of ones. Some example kernels are given in Table 2 below, see Evgeniou et al (1999).

TABLE 2
Examples of kernel functions

| Kernel function | Formula for κ(x − y) |
|---|---|
| Gaussian radial basis | exp(−\|\|x − y\|\|²/a), |
| function | a > 0 |
| Inverse multiquadric | (\|\|x − y\|\|² + c²)^{-1/2} |
| Multiquadric | (\|\|x − y\|\|² + c²)^{1/2} |
| Thin plate splines | \|\|x − y\|\|²ⁿ⁺¹ |
| | \|\|x − y\|\|²ⁿln(\|\|x − y\|\|) |
| Multi layer perceptron | tanh(x · y − θ), for suitable θ |
| Ploynomial of degree d | (1 + x · y)^{d} |
| B splines | B₂ₙ₊₁(x − y) |
| Trigonometric polynomials | sin((d + 1/2)(x − y))/sin((x − y)/ |
| | 2) |

In Table 2 the last two kernels are one dimensional i.e. for the case when X has only one column. Multivariate versions can be derived from products of these kernel functions. The definition of B₂ₙ₊₁ can be found in De Boor(1978). Use of a kernel function in either a generalised linear model or a quasi likelihood model results in mean values which are smooth (as opposed to transforms of linear) functions of the covariates X. Such models may give a substantially better fit to the data.

A fourth embodiment relating to a proportional hazards model will now be described.

D. Proportional Hazard Models

The method of this embodiment may utilise training samples in order to identify a subset of components which are capable of affecting the probability that a defined event (eg death, recovery) will occur within a certain time period. Training samples are obtained from a system and the time measured from when the training sample is obtained to when the event has occurred. Using a statistical method to associate the time to the event with the data obtained from a plurality of training samples, a subset of components may be identified that are capable of predicting the distribution of the time to the event. Subsequently, knowledge of the subset of components can be used for tests, for example clinical tests to predict for example, statistical features of the time to death or time to relapse of a disease. For example, the data from a subset of components of a system may be obtained from a DNA microarray. This data may be used to predict a clinically relevant event such as, for example, expected or median patient survival times, or to predict onset of certain symptoms, or relapse of a disease.

In this way, the present invention identifies preferably a relatively small number of components which can be used to predict the distribution of the time to an event of a system. The selected components are “predictive” for that time to an event. Essentially, from all the data which is generated from the system, the method of the present invention enables identification of a small number of components which can be used to predict time to an event. Once those components have been identified by this method, the components can be used in future to predict statistical features of the time to an event of a system from new samples. The method of the present invention preferably utilises a statistical method to eliminate components that are not required to correctly predict the time to an event of a system. By appropriate selection of the hyperparameters in the model some control over the size of the selected subset can be achieved.

As used herein, “time to an event” refers to a measure of the time from obtaining the sample to which the method of the invention is applied to the time of an event. An event may be any observable event. When the system is a biological system, the event may be, for example, time till failure of a system, time till death, onset of a particular symptom or symptoms, onset or relapse of a condition or disease, change in phenotype or genotype, change in biochemistry, change in morphology of an organism or tissue, change in behaviour.

The samples are associated with a particular time to an event from previous times to an event. The times to an event may be times determined from data obtained from, for example, patients in which the time from sampling to death is known, or in other words, “genuine” survival times, and patients in which the only information is that the patients were alive when samples were last obtained, or in other words, “censored” survival times indicating that the particular patient has survived for at least a given number of days.

In one embodiment, the input data is organised into an n×p data matrix X=(xᵢⱼ) with n test training samples and p components. Typically, p will be much greater than n.

For example, consider an N×p data matrix X=(xᵢⱼ) from, for example, a microarray experiment, with N individuals (or samples) and the same p genes for each individual.

Preferably, there is associated with each individual i(i=1, 2, . . . ,N) a variable yᵢ(yᵢ≧0) denoting the time to an event, for example, survival time. For each individual there may also be defined a variable that indicates whether that individual's survival time is a genuine survival time or a censored survival time. Denote the censor indicators as cᵢ where

$${c}_{i} = \{ \begin{matrix}1 , if {y}_{i} is uncensored \\ 0 , if {y}_{i} is censored\end{matrix}$$

The N×1 vector with survival times yᵢ may be written as {tilde under (y)} and the N×1 vector with censor indicators cᵢ as {tilde under (c)}.

Typically, as discussed above, the component weights are estimated in a manner which takes into account the a priori assumption that most of the component weights are zero.

Preferably, the prior specified for the component weights is of the form

$$P ( {β}_{1} , {β}_{2} , … , {β}_{n} ) = {\int }_{τ} {\prod }_{i = 1}^{N} P ( {β}_{i} \vert {τ}_{i} ) P ( {τ}_{i} ) ⅆ τ \qquad ( D1 )$$

where β₁,β₂, . . . , βₙ are component weights, P(βᵢ|τᵢ) is N(0,τᵢ²) and P(τᵢ) is some hyperprior distribution

$$P ( τ ) = {\prod }_{i = 1}^{n} P ( {τ}_{i} )$$

that is not a Jeffrey's hyperprior.

In one embodiment, the prior distribution is an inverse gamma prior for τ in which tᵢ²=1/τᵢ² has an independent gamma distribution with scale parameter b>0 and shape parameter k>0 so that the density of tᵢ² is
γ(tᵢ²,b,k)=b⁻¹(tᵢ²/b)^{k-1} exp(−tᵢ²/b)/Γ(k).

It can be shown that:
E{t²|β}=(2k+1)/(2/b+β²) (A)

Equation A can be shown as follows:

Define

$$I ( p , b , k ) = {\int }_{0}^{∞} {( {t}^{2} )}^{p} t exp ( - 0.5 {β}^{2} {t}^{2} ) γ ( {t}^{2} , b , k ) ⅆ {t}^{2}$$

then
I(p,b,k)=b^{p+0.5}{σ(p+k+0.5)/σ(k)}(1+0.5β²)^{-p+k+0.5)}

Proof

Let s=β²/2 then

$$I ( p , b , k ) = {b}^{p + 0.5} {\int }_{0}^{∞} {( {t}^{2} / b )}^{p + 0.5} exp ( - s {t}^{2} ) γ ( {t}^{2} , b , k ) ⅆ {t}^{2}$$

Now using the substitution u=t²/b we get

$$I ( p , b , k ) = {b}^{p + 0.5} {\int }_{0}^{∞} {( u )}^{p + 0.5} exp ( - s u b ) γ ( u , l , k ) ⅆ u$$

Now let s′=bs and substitute the expression for γ(u,l,k). This gives

$$I ( p , b , k ) = {b}^{p + 0.5} {\int }_{0}^{∞} exp ( - ( {s}^{′} + 1 ) u ) {u}^{p + k + 0.5 - 1} ⅆ u / Γ ( k )$$

Looking up a table of Laplace transforms, eg Abramowitz and Stegun, then gives the result.

The conditional expectation follows from

$$\begin{matrix}E \{ {t}^{2} \vert β \} = I ( l , b , k ) / I ( 0 , b , k ) \\ = ( 2 k + 1 ) / ( 2 / b + {β}^{2} )\end{matrix}$$

As k tends to zero and b tends to infinity, a result equivalent to using Jeffreys prior is obtained. For example, for k=0.005 and b=2*10⁵
E{t²|β}=(1.01)/(10⁻⁵+β²)

Hence we can get arbitrarily close to a Jeffery's prior with this proper prior.

The modified algorithm for this model has
b⁽ⁿ⁾=E{t²|β⁽ⁿ⁾}^{-0.5}
where the expectation is calculated as above.

In yet another embodiment, the prior distribution is a gamma distribution for τ_{ig}². Preferably, the gamma distribution has scale parameter b>0 and shape parameter k>0.

It can be shown, that

$$\begin{matrix}E \{ {τ}_{i}^{- 2} \vert {β}_{i} \} = \frac{{\int }_{0}^{∞} {u}^{k - 3 / 2 - 1} exp ( - ( {γ}_{i} / u + u ) ) ⅆ u}{b {\int }_{0}^{∞} {u}^{k - 1 / 2 - 1} exp ( - ( {γ}_{i} / u + u ) ) ⅆ u} \\ = \sqrt{\frac{2}{b}} \frac{1}{\vert {β}_{i} \vert} \frac{{K}_{3 / 2 - k} ( 2 \sqrt{{γ}_{i}} )}{{K}_{1 / 2 - k} ( 2 \sqrt{{γ}_{i}} )} \\ = \frac{1}{{\vert {β}_{i} \vert}^{2}} \frac{( 2 \sqrt{{γ}_{i}} ) {K}_{3 / 2 - k} ( 2 \sqrt{{γ}_{i}} )}{{K}_{1 / 2 - k} ( 2 \sqrt{{γ}_{i}} )}\end{matrix}$$

where γᵢ=βᵢ²/2b and K denotes a modified Bessel function. Some special members of this class are k=1 in which case
E{τᵢ⁻²|βᵢ}=\sqrt{2/b}(1/|βᵢ|)
which corresponds to the prior used in the Lasso technique, Tibshirani(1996). See also Figueiredo (2001).

The case k=0.5 gives
E{τᵢ⁻²|βᵢ}=\sqrt{2/b}(1/|βᵢ|){K₁(2\sqrt{γᵢ})/K₀(2\sqrt{γᵢ})}
or equivalently
E{τᵢ⁻²|βᵢ}=(1/|βᵢ|²){2\sqrt{γᵢ}K₁(2\sqrt{γᵢ})/K₀(2\sqrt{γᵢ})}
where K₀ and K₁ are modified Bessel functions, see Abramowitz and Stegun(1970). Polynomial approximations for evaluating these Bessel functions can be found in Abramowitz and Stegun (1970, p 379).

The expressions above demonstrate the connection with the Lasso model and the Jeffreys prior model.

Details of the above calculations are as follows:

For the gamma prior above and γᵢ=βᵢ²/2b

$$\begin{matrix}E \{ {τ}_{i}^{- 2} \vert {β}_{i} \} = \frac{{\int }_{0}^{∞} {u}^{k - 3 / 2 - 1} exp ( - ( {γ}_{i} / u + u ) ) ⅆ u}{b {\int }_{0}^{∞} {u}^{k - 1 / 2 - 1} exp ( - ( {γ}_{i} / u + u ) ) ⅆ u} \\ = \sqrt{\frac{2}{b}} \frac{1}{\vert {β}_{i} \vert} \frac{{K}_{3 / 2 - k} ( 2 \sqrt{{γ}_{i}} )}{{K}_{1 / 2 - k} ( 2 \sqrt{{γ}_{i}} )} \\ = \frac{1}{{\vert {β}_{i} \vert}^{2}} \frac{( 2 \sqrt{{γ}_{i}} ) {K}_{3 / 2 - k} ( 2 \sqrt{{γ}_{i}} )}{{K}_{1 / 2 - k} ( 2 \sqrt{{γ}_{i}} )}\end{matrix} \qquad ( D2 )$$

where K denotes a modified Bessel function.

For k=1 in (D2)
E{τᵢ⁻²|βᵢ}=\sqrt{2/b}(1/|βᵢ|)

For K=0.5 in (D2)
E{τᵢ⁻²|βᵢ}=\sqrt{2/b}(1/|βᵢ|){K₁(2\sqrt{γᵢ})/K₀(2\sqrt{γᵢ})}
or equivalently
E{τᵢ⁻²|βᵢ}=(1/|βᵢ|²){2\sqrt{γᵢ}K₁(2\sqrt{γᵢ})/K₀(2\sqrt{γᵢ})}

Proof

From the definition of the conditional expectation, writing γᵢ=βᵢ²/2b, we get

$$E \{ {τ}_{i}^{- 2} \vert {β}_{i} \} = \frac{{\int }_{0}^{∞} {τ}_{i}^{- 2} {τ}_{i}^{- 1} exp ( - {γ}_{i} {τ}_{i}^{- 2} ) {{b}^{- 1} ( {τ}_{i}^{- 2} / b )}^{k - 1} exp ( {τ}_{i}^{- 2} / b ) ⅆ {τ}_{i}^{2}}{{\int }_{0}^{∞} {τ}_{i}^{- 1} exp ( - {γ}_{i} {τ}^{- 2} ) {{b}^{- 1} ( {τ}_{i}^{- 2} / b )}^{k - 1} exp ( {τ}_{i}^{- 2} / b ) ⅆ {τ}_{i}^{2}}$$

Rearranging, simplifying and making the substitution u=νᵢ²/b gives A.1

The integrals in A.1 can be evaluated by using the result

$${\int }_{0}^{∞} {x}^{- b - 1} exp [ - ( x + \frac{{a}^{2}}{x} ) ] ⅆ x = \frac{2}{{a}^{b}} {K}_{b} ( 2 a )$$

where K denotes a modified Bessel function, see Watson(1966).

In a particularly preferred embodiment, p(τᵢ)α1/τᵢ² is a Jeffreys prior, Kotz and Johnson(1983).

The likelihood function defines a model which fits the data based on the distribution of the data. Preferably, the likelihood function is of the form:

$$Log ( Partial ) Likelihood = {\sum }_{i = 1}^{N} {g}_{i} ( {β}_{∼} , {φ}_{∼} ; X , {y}_{∼} , {c}_{∼} )$$

where {tilde under (β)}^{T}=(β₁,β₂, . . . ,βₚ) and {tilde under (φ)}^{T}=(φ₁,φ₂, . . . ,φ_{q}) are the model parameters. The model defined by the likelihood function may be any model for predicting the time to an event of a system.

In one embodiment, the model defined by the likelihood is Cox's proportional hazards model. Cox's proportional hazards model was introduced by Cox (1972) and may preferably be used as a regression model for survival data. In Cox's proportional hazards model, {tilde under (β)}¹ is a vector of (explanatory) parameters associated with the components. Preferably, the method of the present invention provides for the parsimonious selection (and estimation) from the parameters {tilde under (β)}¹=(β₁,β₂, . . . ,βₚ) for Cox's proportional hazards model given the data X, {tilde under (y)} and {tilde under (c)}.

Application of Cox's proportional hazards model can be problematic in the circumstance where different data is obtained from a system for the same survival times, or in other words, tied survival times. Tied survival times may be subjected to a pre-processing step that leads to unique survival times. The pre-processing proposed simplifies the ensuing code as it avoids concerns about tied survival times in the subsequent application of Cox's proportional hazards model.

The pre-processing of the survival times applies by adding an extremely small amount of insignificant random noise. Preferably, the procedure is to take sets of tied times and add to each tied time within a set of tied times a random amount that is drawn from a normal distribution that has zero mean and variance proportional to the smallest non-zero distance between sorted survival times. Such pre-processing achieves an elimination of tied times without imposing a draconian perturbation of the survival times.

The pre-processing generates distinct survival times. Preferably, these times may be ordered in increasing magnitude denoted as {tilde under (t)}=(t₍₁₎,t₍₂₎, . . . t_{(N)}), t(_{i+1)>t}₍ᵢ₎.

Denote by Z the Nxp matrix that is the re-arrangement of the rows of X where the ordering of the rows of Z corresponds to the ordering induced by the ordering of {tilde under (t)}; also denote by Zⱼ the j^{th} row of the matrix Z. Let d be the result of ordering c with the same permutation required to order {tilde under (t)}.

After pre-processing for tied survival times is taken into account and reference is made to standard texts on survival data analysis (eg Cox and Oakes, 1984), the likelihood function for the proportional hazards model may preferably be written as

$$l ( {t}_{∼} \vert {β}_{∼} ) = {\prod }_{j = 1}^{N} {( \frac{exp ( {Z}_{j} {β}_{∼} )}{{\sum }_{i ∈ {ℜ}_{j}} exp ( {Z}_{i} {β}_{∼} )} )}^{{d}_{j}} \qquad ( D3 )$$

where {tilde under (β)}^{T}=(β₁,β₂, . . . ,βₙ) , Zⱼ=the j^{th} row of Z, and [symbol] ⱼ{i:i=j,j+1, . . . ,N}=the risk set at the j^{th} ordered event time t₍ⱼ₎.

The logarithm of the likelihood (ie L=log(l)) may preferably be written as

$$\begin{matrix}L ( {t}_{∼} \vert {β}_{∼} ) = {\sum }_{i = l}^{N} {d}_{i} ( {Z}_{i} {β}_{∼} - log ( {\sum }_{j ∈ {ℜ}_{i}} exp ( {Z}_{j} {β}_{∼} ) ) ) \\ = {\sum }_{i = l}^{N} {d}_{i} ( {Z}_{i} {β}_{∼} - log ( {\sum }_{j = 1}^{N} {{ζ}_{i , j}}_{} exp ( {Z}_{j} {β}_{∼} ) ) ) ,\end{matrix} \qquad ( D4 )$$

where

$${ζ}_{i , j} = \{ \begin{matrix}0 , & if j < i \\ 1 , & if j \geq i\end{matrix}$$

Notice that the model is non-parametric in that the parametric form of the survival distribution is not specified—preferably only the ordinal property of the survival times are used (in the determination of the risk sets). As this is a non-parametric case {tilde under (φ)} is not required (ie q=0).

In another embodiment of the method of the invention, the model defined by the likelihood function is a Parametric survival model. Preferably, in a parametric survival model, {tilde under (β)}¹ is a vector of (explanatory) parameters associated with the components, and {tilde under (φ)}¹ is a vector of parameters associated with the functional form of the survival density function.

Preferably, the method of the invention provides for the parsimonious selection (and estimation) from the parameters {tilde under (β)}¹ and the estimation of {tilde under (φ)}¹=(φ₁,φ₂, . . . ,φ_{q}) for parametric survival models given the data X, {tilde under (y)} and {tilde under (c)}.

In applying a parametric survival model, the survival times do not require pre-processing and are denoted as {tilde under (y)}. The parametic survival model is applied as follows: Denote by f(y;{tilde under (θ)},{tilde under (β)},X) the parametric density function of the survival time, denote its survival function by

$$𝕊 ( y ; {φ}_{∼} , {β}_{∼} , X ) = {\int }_{y}^{∞} f ( u ; {φ}_{∼} , {β}_{∼} , X ) ⅆ u$$

where {tilde under (φ)} are the parameters relevant to the parametric form of the density function and {tilde under (β)},X are as defined above. The hazard function is defined as h(yᵢ;{tilde under (φ)},{tilde under (β)},X)=f(yᵢ;{tilde under (φ)},{tilde under (β)},X)/S(yᵢ;{tilde under (φ)},{tilde under (β)},X).

Preferably, the generic formulation of the log-likelihood function, taking censored data into account, is

$$L = {\sum }_{i = 1}^{N} \{ {c}_{i} log ( f ( {y}_{i} ; {φ}_{∼} , {β}_{∼} , X ) ) + ( 1 - {c}_{i} ) log ( 𝕊 ( {y}_{i} ; {φ}_{∼} , {β}_{∼} , X ) ) \}$$

Reference to standard texts on analysis of survival time data via parametric regression survival models reveals a collection of survival time distributions that may be used. Survival distributions that may be used include, for example, the Weibull, Exponential or Extreme Value distributions.

If the hazard function may be written as h(yᵢ;{tilde under (φ)},{tilde under (β)},X)=λ(yᵢ;{tilde under (φ)})exp(Xᵢ{tilde under (β)}) then S(yᵢ;{tilde under (φ)},{tilde under (β)},X)=exp(−Λ(yᵢ;{tilde under (φ)})e^{X}^{ᵢ}^{{tilde under (β)}}) and f(yᵢ;{tilde under (φ)},{tilde under (β)},X)=λ(yᵢ;{tilde under (φ)})exp(Xᵢ{tilde under (β)}−Λ(yᵢ)e^{X}^{ᵢ}^{{tilde under (β)}}) where Λ(yᵢ;{tilde under (φ)})=∫_{-∞}^{y}^{ᵢ}λ(u;{tilde under (φ)})du is the integrated hazard function and

$$λ ( {y}_{i} ; {φ}_{∼} ) = \frac{ⅆ Λ ( {y}_{i} ; {φ}_{∼} )}{ⅆ {y}_{i}} ;$$

Xᵢ is the i^{th} row of X.

The Weibull, Exponential and Extreme Value distributions have density and hazard functions that may be written in the form of those presented in the paragraph immediately above.

The application detailed relies in part on an algorithm of Aitken and Clayton (1980) however it permits the user to specify any parametric underlying hazard function.

Following from Aitkin and Clayton (1980) a preferred likelihood function which models a parametic survival model is:

$$L = {\sum }_{i = 1}^{N} \{ {c}_{i} log ( {μ}_{i} ) - {μ}_{i} + {c}_{i} ( log ( \frac{λ ( {y}_{i} )}{Λ ( {y}_{i} ; {φ}_{∼} )} ) ) \} \qquad ( D5 )$$

where μᵢ=λ(yᵢ;{tilde under (φ)})exp(Xᵢ{tilde under (β)}). Aitkin and Clayton (1980) note that a consequence of equation (11) is that the cᵢ's may be treatedas Poisson variates with means μᵢ and that the last term in equation (11) does not depend on {tilde under (β)} (although it depends on {tilde under (φ)}).

Preferably, the posterior distribution of {tilde under (β)}, {tilde under (φ)} and {tilde under (τ)} given {tilde under (y)} is
P({tilde under (β)}, {tilde under (φ)}, {tilde under (τ)}, |{tilde under (yc)}) α l({tilde under (y)}|{tilde under (β)},{tilde under (φ)}, {tilde under (c)})P({tilde under (β)}|{tilde under (τ)})P({tilde under (τ)}) (D6)
wherein l({tilde under (y)}|{tilde under (β)}, {tilde under (φ)}, {tilde under (c)}) is the likelihood function.

In one embodiment, {tilde under (τ)} may be treated as a vector of missing data and an iterative procedure used to maximise equation (D6) to produce a posteriori estimates of {tilde under (β)}. The prior of equation (D1) is such that the maximum a posteriori estimates will tend to be sparse i.e. if a large number of parameters are redundant, many components of {tilde under (β)} will be zero.

Because a prior expectation exists that many components of {tilde under (β)}¹ are zero, the estimation may be performed in such a way that most of the estimated βᵢ's are zero and the remaining non-zero estimates provide an adequate explanation of the survival times. In the context of microarray data this exercise translates to identifying a parsimonious set of genes that provide an adequate explanation for the event times.

As stated above, the component weights which maximise the posterior distribution may be determined using an iterative procedure. Preferable, the iterative procedure for maximising the posterior distribution of the components and component weights is an EM algorithm, such as, for example, that described in Dempster et al, 1977.

If the E step of the EM algorithm is examined, from (D6) ignoring terms not involving beta, it is necessary to compute

$${\sum }_{i = 1}^{n} E \text{\{} {β}_{i}^{2} / {τ}_{i}^{2} \vert {\hat{β}}_{i} \} = {\sum }_{i = 1}^{n} {β}_{i}^{2} / {\hat{d}}_{i}^{2} \qquad ( D7 )$$

where \hat{d}ᵢ=dᵢ(\hat{β}ᵢ)=E{1/vᵢ²|\hat{β}ᵢ}^{-0.5} and for convenience we define \hat{d}ᵢ=1/\hat{d}ᵢ=0 if \hat{β}ᵢ=0. In the following we write \hat{d}=d(\hat{β})=(\hat{d}₁,\hat{d}₂, . . . ,\hat{d}ₙ)^{T}. In a similar manner we define for example d(β⁽ⁿ⁾) and d(γ⁽ⁿ⁾)=Pₙ^{T}(Pₙγ⁽ⁿ⁾) where β⁽ⁿ⁾=Pₙγ⁽ⁿ⁾ and Pₙ is obtained from the p by p identity matrix by omitting columns j for which βⱼ⁽ⁿ⁾=0.

Hence to do the E step requires the calculation of the conditional expected value of tᵢ²=1/τᵢ² when p(βᵢ|τᵢ²) is N(0,τᵢ²) and p(τᵢ²)has a specified prior distribution as discussed above.

In one embodiment, the EM algorithm comprises the steps:

1. Choose the hyperprior and values for its parameters, namely b and k. Initialising the algorithm by setting n=0, s₀={1, 2, . . . , p}, initialise {tilde under (β)}⁽⁰⁾={tilde under (β)}*, {tilde under (φ)}⁽⁰⁾,

2. Defining

$${β}_{i}^{( n )} = \{ \begin{matrix}{β}_{i}^{*} , & i ɛ {S}_{n} \\ 0 , & otherwise\end{matrix}$$

and let Pₙ be a matrix of zeroes and ones such that the nonzero elements {tilde under (γ)}⁽ⁿ⁾ of {tilde under (β)}⁽ⁿ⁾ satisfy
{tilde under (γ)}⁽ⁿ⁾=Pₙ^{T}{tilde under (β)}⁽ⁿ⁾, {tilde under (β)}⁽ⁿ⁾=Pₙ{tilde under (γ)}⁽ⁿ⁾
{tilde under (γ)}=Pₙ^{T}{tilde under (β)}, {tilde under (β)}=Pₙ{tilde under (γ)} (D8)

3. Performing an estimation step by calculating the expected value of the posterior distribution of component weights. This may be performed using the function:

$$\begin{matrix}Q ( {β}_{∼} \vert {{β}_{∼}}^{( n )} , {φ}^{( n )} ) = E \{ log ( P ( {β}_{∼} , {φ}_{∼} , τ \vert {y}_{∼} ) ) \vert {y}_{∼} , {{β}_{∼}}^{( n )} , {φ}^{( n )} \} \\ = L \text{(} {y}_{∼} \text{\textbar} {β}_{∼} , {φ}^{( n )} \text{)} - \frac{1}{2} {\sum }_{i = 1}^{p} {( \frac{{β}_{i}}{{d}_{i} ( {β}^{( n )} )} )}^{2}\end{matrix} \qquad ( D9 )$$

where L is the log likelihood function of {tilde under (y)}. Using β=Pₙγ and β⁽ⁿ⁾=Pₙγ⁽ⁿ⁾ we have

$$Q ( {γ}_{∼} \vert {{γ}_{∼}}^{( n )} , {{φ}_{∼}}^{( n )} ) = L ( {t}_{∼} \vert {P}_{n} {γ}_{∼} , {{φ}_{∼}}^{( n )} ) - \frac{1}{2} {γ}^{T} Δ ( d ( {γ}^{( n )} ) ) γ \qquad ( D10 )$$

4. Performing the maximisation step. This may be performed using Newton Raphson iterations as follows: Set {tilde under (γ)}₀={tilde under (γ)}^{(r)} and for r=0, 1, 2, . . . {tilde under (γ)}ᵣ₊₁={tilde under (γ)}ᵣ+αᵣ{tilde under (δ)}ᵣ where αᵣ is chosen by a line search algorithm to ensure Q({tilde under (γ)}ᵣ₊₁|{tilde under (γ)}⁽ⁿ⁾,{tilde under (φ)}⁽ⁿ⁾)>Q({tilde under (γ)}ᵣ|{tilde under (γ)}⁽ⁿ⁾,{tilde under (φ)}⁽ⁿ⁾), and

$${{δ}_{r}}_{∼} = Δ {( d ( {{γ}_{∼}}^{( n )} ) ) [ - Δ ( d ( {{γ}_{∼}}^{( n )} ) ) \frac{{\partial }^{2} L}{{\partial }^{2} {{γ}_{r}}_{∼}} Δ ( d ( {{γ}_{∼}}^{( n )} ) ) + I ]}^{- 1} ( \frac{\partial L}{\partial {{γ}_{r}}_{∼}} - \frac{{{γ}_{r}}_{∼}}{d ( {{γ}_{∼}}^{( n )} )} ) \\ where \\ \frac{\partial L}{\partial {{γ}_{r}}_{∼}} = {P}_{n}^{T} \frac{\partial L}{\partial {{β}_{r}}_{∼}} , \frac{{\partial }^{2} L}{{\partial }^{2} {{γ}_{r}}_{∼}} = {P}_{n}^{T} \frac{{\partial }^{2} L}{{\partial }^{2} {{β}_{r}}_{∼}} {P}_{n} for {{β}_{r}}_{∼} = {P}_{n} {{{γ}_{r}}_{∼}}_{} \qquad ( D11 )$$

Let {tilde under (γ)}* be the value of {tilde under (γ)}ᵣ when some convergence criterion is satisfied e.g ∥{tilde under (γ)}ᵣ−{tilde under (γ)}ᵣ₊₁∥<ε (for example ε=10⁻⁵)

5. Define {tilde under (β)}*=Pₙ{tilde under (γ)}*,

$${S}_{n} = \{ i : \vert {β}_{i} \vert > {ɛ}_{1} {max}_{j} \vert {β}_{j} \vert \}$$

where ε₁ is a small constant, say 10⁻⁵. Set n=n+1, choose {tilde under (φ)}⁽ⁿ⁺¹⁾={tilde under (φ)}⁽ⁿ⁾+κₙ({tilde under (φ)}*−{tilde under (φ)}⁽ⁿ⁾) where {tilde under (φ)}* satisfies

$$\frac{\partial L ( {y}_{∼} \vert {P}_{n} {{γ}_{∼}}^{*} , {φ}_{∼} )}{\partial {φ}_{∼}} = 0$$

and κₙ is a damping factor such that 0<κₙ<1.

6. Check convergence. If ∥{tilde under (γ)}*−{tilde under (γ)}⁽ⁿ⁾∥<ε₂ where ε₂ is suitably small then stop, else go to step 2 above.

In another embodiment, step (D11) in the maximisation step may be estimated by replacing

$$\frac{{\partial }^{2} L}{{\partial }^{2} {γ}_{r}}$$

with its expectation

$$E \{ \frac{{\partial }^{2} L}{{\partial }^{2} {γ}_{r}} \} .$$

In one embodiment, the EM algorithm is applied to maximise the posterior distribution when the model is Cox's proportional hazard's model.

To aid in the exposition of the application of the EM algorithm when the model is Cox's proportional hazards model, it is preferred to define “dynamic weights” and matrices based on these weights. The weights are

$${w}_{i , l} = \frac{{ζ}_{i , l} exp ( {Z}_{l} {β}_{∼} )}{{\sum }_{j = 1}^{N} {ζ}_{i , j} exp ( {Z}_{j} {β}_{∼} )} , \\ {w}_{l}^{*} = {\sum }_{i = 1}^{N} {d}_{i} {w}_{i , l} , \\ {\tilde{w}}_{l} = {d}_{l} - {w}_{l}^{*} .$$

Matrices based on these weights are

$${W}_{i} = ( \begin{matrix}{w}_{i , 1} \\ {w}_{i , 2} \\ ⋮ \\ ⋮ \\ {w}_{i , N}\end{matrix} ) , \\ \tilde{W} = ( \begin{matrix}{\tilde{w}}_{1} \\ {\tilde{w}}_{2} \\ ⋮ \\ ⋮ \\ {\tilde{w}}_{N}\end{matrix} ) , \\ Δ ( {W}^{*} ) = ( \begin{matrix}{w}_{1}^{*} & ⋯ & 0 \\ ⋮ & ⋰ & ⋮ \\ 0 & ⋯ & {w}_{N}^{*}\end{matrix} ) , \\ {W}^{* ⋆} = {\sum }_{i = 1}^{N} {d}_{i} {W}_{i} {W}_{i}^{T}$$

In terms of the matrices of weights the first and second derivatives of L may be written as

$$\begin{matrix}\frac{\partial L}{\partial {β}_{∼}} = {Z}^{T} \tilde{W} \\ \frac{{\partial }^{2} L}{\partial {{β}_{∼}}^{2}} = {Z}^{T} ( {W}^{**} - Δ ( {W}^{*} ) ) Z = {Z}^{T} KZ\end{matrix} \} \qquad ( D12 )$$

where K=W −Δ(W). Note therefore from the transformation matrix Pₙ described as part of Step (2) of the EM algorithm (Equation D8) (see also Equations (D11)) it follows that

$$\begin{matrix}\frac{\partial L}{\partial {{γ}_{r}}_{∼}} = {P}_{n}^{T} \frac{\partial L}{\partial {{β}_{r}}_{∼}} = {P}_{n}^{T} {Z}^{T} \tilde{W} \\ \frac{{\partial }^{2} L}{\partial {{γ}_{r}^{2}}_{∼}} = {P}_{n}^{T} \frac{{\partial }^{2} L}{\partial {{β}_{r}^{2}}_{∼}} {P}_{n} = {P}_{n}^{T} {Z}^{T} ( {W}^{**} - Δ ( {W}^{*} ) ) {ZP}_{n} = {P}_{n}^{T} {Z}^{T} {KZP}_{n}\end{matrix} \} \qquad ( D13 )$$

Preferably, when the model is Cox's proportional hazards model the E step and M step of the EM algorithm are as follows:

1. Choose the hyperprior and its parameters b and k. Set n=0, S₀={1, 2, . . . , p}. Let v be the vector with components

$${V}_{i} = \{ \begin{matrix}1 - ∈ , & if {c}_{i} = 1 \\ ∈ , & if {c}_{i} = 0\end{matrix}$$

for some small ε, say 0.001. Define f to be log(v/t).
If p≦N compute initial values {tilde under (β)}* by
   {tilde under (β)}*=(Z^{T}Z+λI)⁻¹Z^{T}f
If p>N compute initial values {tilde under (β)}* by

$${{β}_{∼}}^{*} = \frac{1}{λ} ( I - {{Z}^{T} ( {ZZ}^{T} + λ I )}^{- 1} Z ) {Z}^{T} f$$

where the ridge parameter λ satisfies 0<λ≦1.

2. Define

$${β}_{i}^{( n )} = \{ \begin{matrix}{β}_{i}^{*} , & i ∈ {S}_{n} \\ 0 , & otherwise\end{matrix}$$

Let Pₙ be a matrix of zeroes and ones such that the nonzero elements {tilde under (γ)}⁽ⁿ⁾ of {tilde under (β)}⁽ⁿ⁾ satisfy
{tilde under (γ)}⁽ⁿ⁾=Pₙ^{T}{tilde under (β)}⁽ⁿ⁾, {tilde under (β)}⁽ⁿ⁾=Pₙ{tilde under (γ)}⁽ⁿ⁾
{tilde under (γ)}=Pₙ^{T}{tilde under (β)}, {tilde under (β)}=Pₙ{tilde under (γ)}

3. Perform the E step by calculating

$$\begin{matrix}Q ( {β}_{∼} \text{\vert} {{β}_{∼}}^{( n )} ) = E \{ log ( P ( {β}_{∼} , {φ}_{∼} , τ \text{\vert} {t}_{∼} ) ) \vert {t}_{∼} , {{β}_{∼}}^{( n )} \} \\ = L ( {t}_{∼} \text{\vert} {β}_{∼} ) - \frac{1}{2} {\sum }_{i = 1}^{N} {( \frac{{β}_{i}}{{d}_{i} ( {β}^{( n )} )} )}^{2}\end{matrix}$$

where L is the log likelihood function of {tilde under (t)} given by Equation (8). Using β=Pₙγ and β⁽ⁿ⁾=Pₙγ⁽ⁿ⁾ we have

$$Q ( {γ}_{∼} \text{\vert} {{γ}_{∼}}^{( n )} ) = L ( {t}_{∼} \text{\vert} {P}_{n} {γ}_{∼} ) - \frac{1}{2} {γ}^{T} Δ ( d ( {γ}^{( n )} ) ) γ$$

4. Do the M step. This can be done with Newton Raphson iterations as follows. Set {tilde under (γ)}₀={tilde under (γ)}^{(r)} and for r=0, 1, 2, . . . {tilde under (γ)}ᵣ₊₁={tilde under (65 )}ᵣ+αᵣ{tilde under (δ)}ᵣ where αᵣ is chosen by a line search algorithm to ensure Q({tilde under (γ)}ᵣ₊₁|{tilde under (γ)}⁽ⁿ⁾,{tilde under (φ)}⁽ⁿ⁾)>Q({tilde under (γ)}ᵣ|{tilde under (γ)}⁽ⁿ⁾,{tilde under (φ)}⁽ⁿ⁾).
For p≦N use
   {tilde under (δ)}ᵣ=Δ(d({tilde under (γ)}⁽ⁿ⁾))(Y^{T}KY+I)⁻¹(Y^{T}\tilde{W}−Δ(1/d({tilde under (γ)}⁽ⁿ⁾)){tilde under (γ)}),

where Y=ZPₙΔ(d({tilde under (γ)}⁽ⁿ⁾)).
For p>N use
   {tilde under (δ)}ᵣ=Δ(d({tilde under (γ)}⁽ⁿ⁾))(I−Y^{T}(YY^{T}+K⁻¹)⁻¹Y)(Y^{T}\tilde{W}−Δ(1/d({tilde under (γ)}⁽ⁿ⁾)){tilde under (γ)})

Let γ* be the value of γᵣ when some convergence criterion is satisfied e.g ∥γᵣ−γᵣ₋₁∥<ε (for example 10⁻⁵).

5. Define {tilde under (β)}*=Pₙ{tilde under (γ)}* ,

$${S}_{n} = \{ i \text{:} \vert {β}_{i} \vert > {ɛ}_{1} {max}_{j} \vert {β}_{j} \vert \}$$

where ε₁ is a small constant, say 10⁻⁵. This step eliminates variables with very small coefficients.

6. Check convergence. If ∥{tilde under (γ)}*−{tilde under (γ)}⁽ⁿ⁾∥<ε₂ where ε₂ is suitably small then stop, else set n=n+1, go to step 2 above and repeat procedure until convergence occurs.

In another embodiment the EM algorithm is applied to maximise the posterior distribution when the model is a parametric survival model.

In applying the EM algorithm to the parametic survival model, a consequence of equation (11) is that the cᵢ's may be treated as Poisson variates with means μᵢ_{ⁱ} and that the last term in equation (11) does not depend on β (although it depends on φ). Note that log(μᵢ)=log(Λ(yᵢ;{tilde under (φ)}))+Xᵢ{tilde under (β)} and so it is possible to couch the problem in terms of a log-linear model for the Poisson-like mean. Preferably, an iterative maximization of the log-likelihood function is performed where given initial estimates of {tilde under (φ)} the estimates of {tilde under (β)} are obtained. Then given these estimates of {tilde under (β)}, updated estimates of {tilde under (φ)} are obtained. The procedure is continued until convergence occurs.

Applying the posterior distribution described above, we note that (for fixed φ)

$$\frac{\partial log ( μ )}{\partial {β}_{∼}} = \frac{1}{μ} \frac{\partial μ}{\partial {β}_{∼}} ⇔ \frac{\partial μ}{\partial {β}_{∼}} = μ \frac{\partial log ( μ )}{\partial {β}_{∼}} and \frac{\partial log ( {μ}_{i} )}{\partial {β}_{∼}} = {X}_{i} \qquad ( D14 )$$

Consequently from Equations (11) and (12) it follows that

$$\frac{\partial L}{\partial {β}_{∼}} = {X}^{T} ( {c}_{∼} - {μ}_{∼} ) and \frac{{\partial }^{2} L}{\partial {{β}_{∼}}^{2}} = - {X}^{T} Δ ( {μ}_{∼} ) X .$$

The versions of Equation (12) relevant to the parametric survival models are

$$\begin{matrix} \frac{\partial L}{\partial {{γ}_{r}}_{∼}} = {P}_{n}^{T} \frac{\partial L}{\partial {{β}_{r}}_{∼}} = {P}_{n}^{T} {X}^{T} ( {c}_{∼} - {{μ}_{∼}}_{} ) \\ \frac{{\partial }^{2} L}{\partial {{γ}_{r}^{2}}_{∼}} = {P}_{n}^{T} \frac{{\partial }^{2} L}{\partial {{β}_{r}^{2}}_{∼}} {P}_{n} = - {P}_{n}^{T} {X}^{T} Δ ( {μ}_{∼} ) {XP}_{n}\end{matrix} \} \qquad ( D15 )$$

To solve for {tilde under (φ)} after each M step of the EM algorithm (see step 5 below) preferably put {tilde under (φ)}⁽ⁿ⁺¹⁾={tilde under (φ)}⁽ⁿ⁺¹⁾+κₙ({tilde under (φ)}*−{tilde under (φ)}⁽ⁿ⁾) where {tilde under (φ)}* satisfies

$$\frac{\partial L}{\partial {φ}_{∼}} = 0$$

for 0<κₙ≦1 and β is fixed at the value obtained from the previous M step.

It is possible to provide an EM algorithm for parameter selection in the context of parametric survival models and microarray data. Preferably, the EM algorithm is as follows:

1. Choose a hyper prior and its parameters b and k eg b=1e7 and k=0.5. Set n=0, S₀={1, 2, . . . ,p} {tilde under (φ)}^{(initial)}={tilde under (φ)}⁽⁰⁾. Let v be the vector with components

$${v}_{i} = \{ \begin{matrix} 1 - ∈ , & if & {c}_{i} = 1 \\ ∈ , & if & {c}_{i} = 0\end{matrix}$$

for some small ε, say for example 0.001. Define f to be log(v/Λ(y,φ)).
If p ≦N compute initial values {tilde under (β)}* by {tilde under (β)}*=(X^{T}X+λI)⁻¹X^{T}f.
If p >N compute initial values {tilde under (β)}* by

$${{β}_{∼}}^{*} = \frac{1}{λ} ( I - {{X}^{T} ( {XX}^{T} + λ I )}^{- 1} X ) {X}^{T} f$$

where the ridge parameter λ satisfies 0<λ≦1.

2. Define

$${β}_{i}^{( n )} = \{ \begin{matrix}{β}_{i}^{*} , & i ∈ {S}_{n} \\ 0 , & otherwise\end{matrix}$$

Let Pₙ be a matrix of zeroes and ones such that the nonzero elements {tilde under (γ)}⁽ⁿ⁾ of {tilde under (β)}⁽ⁿ⁾ satisfy
{tilde under (γ)}⁽ⁿ⁾=Pₙ^{T}{tilde under (β)}⁽ⁿ⁾, {tilde under (β)}⁽ⁿ⁾=P_{n{tilde under (γ)}}⁽ⁿ⁾
{tilde under (γ)}=Pₙ^{T}{tilde under (β)}, {tilde under (β)}=Pₙ{tilde under (γ)}

3. Perform the E step by calculating

$$\begin{matrix}Q ( {β}_{∼} \vert {{{β}_{∼}}^{( n )} , {{φ}_{∼}}^{( n )}}_{} = E \{ log ( P ( {β}_{∼} , {φ}_{∼} , τ \vert {y}_{∼} ) ) \vert {y}_{∼} , {{β}_{∼}}^{( n )} , {{φ}_{∼}}^{( n )} \} \\ = L ( {y}_{∼} \vert {β}_{∼} , {{φ}_{∼}}^{( n )} ) - \frac{1}{2} {\sum }_{i = 1}^{N} {( \frac{{β}_{i}}{d ( {β}^{( n )} )} )}^{2}\end{matrix}$$

where L is the log likelihood function of {tilde under (γ)} and {tilde under (φ)}⁽ⁿ⁾.

Using β=Pₙγ and β⁽ⁿ⁾=Pₙγ⁽ⁿ⁾ we have

$$Q ( {γ}_{∼} \vert {{γ}_{∼}}^{( n )} , {{φ}_{∼}}^{( n )} ) = L ( {y}_{∼} \vert {P}_{n} {γ}_{∼} , {{φ}_{∼}}^{( n )} ) - \frac{1}{2} {γ}^{T} Δ ( d ( {γ}^{( n )} ) ) γ$$

4. Do the M step. This can be done with Newton Raphson iterations as follows. Set {tilde under (γ)}₀={tilde under (γ)}^{(r)} and for r=0, 1, 2, . . . {tilde under (γ)}ᵣ₊₁={tilde under (γ)}ᵣ+αᵣ{tilde under (δ)}ᵣ where αᵣ is chosen by a line search algorithm to ensure Q({tilde under (γ)}ᵣ₊₁|{tilde under (γ)}⁽ⁿ⁾,{tilde under (φ)}⁽ⁿ⁾)>Q({tilde under (γ)}ᵣ|{tilde under (γ)}⁽ⁿ⁾,{tilde under (φ)}⁽ⁿ⁾).
For p≦N use
   {tilde under (δ)}ᵣ=−Δ(d({tilde under (γ)}⁽ⁿ⁾))[Yₙ^{T}Δ({tilde under (μ)})Yₙ+I]⁻¹(Yₙ^{T}({tilde under (c)}−{tilde under (μ)})−Δ(1/d({tilde under (γ)}⁽ⁿ⁾)){tilde under (γ)})
   where Y=XPₙΔ(d({tilde under (γ)}⁽ⁿ⁾)).
For p>N use
   {tilde under (δ)}ᵣ=−Δ(d({tilde under (γ)}⁽ⁿ⁾))(I−Y^{T}(YY^{T}+Δ(1/{tilde under (μ)}))⁻¹Y)(Yₙ^{T}({tilde under (c)}−{tilde under (μ)})−Δ(1/d({tilde under (γ)}⁽ⁿ⁾)){tilde under (γ)})

Let γ* be the value of γᵣ when some convergence criterion is satisfied e.g ∥γᵣ−γᵣ₊₁∥<ε (for example 10⁻⁵) .

5. Define {tilde under (β)}*=Pₙ{tilde under (γ)}*,

$${S}_{n} = \{ i : \vert {β}_{i} \vert > {ɛ}_{1} {max}_{j} \vert {β}_{j} \vert \}$$

where ε₁ is a small constant, say 10⁻⁵. Set n=n+1, choose {tilde under (φ)}⁽ⁿ⁺¹⁾={tilde under (φ)}⁽ⁿ⁾+κₙ({tilde under (φ)}*−{tilde under (φ)}⁽ⁿ⁾) where {tilde under (φ)}* satisfies

$$\frac{\partial L ( {y}_{∼} \vert {P}_{n} {{γ}_{∼}}^{*} , {φ}_{∼} )}{\partial {φ}_{∼}} = 0$$

and κₙ is a damping factor such that 0<κₙ<1.

6. Check convergence. If ∥{tilde under (γ)}*−{tilde under (γ)}⁽ⁿ⁾∥<ε₂ where ε₂ is suitably small then stop, else go to step 2.

In another embodiment, survival times are described by a Weibull survival density function. For the Weibull case {tilde under (φ)} is preferably one dimensional and
λ(y;{tilde under (φ)})=y^{α},
Λ(y;{tilde under (φ)})=αy^{α-1},
{tilde under (φ)}=α

Preferably,

$$\frac{\partial L}{\partial α} = \frac{N}{α} + {\sum }_{i = 1}^{N} ( {c}_{i} - {μ}_{i} ) log ( {y}_{i} ) = 0$$

is solved after each M step so as to provide an updated value of α.

Following the steps applied for Cox's proportional hazards model, one may estimate α and select a parsimonious subset of parameters from {tilde under (β)} that can provide an adequate explanation for the survival times if the survival times follow a Weibull distribution. A numerical example is now given.

The preferred embodiment of the present invention will now be described by way of reference only to the following non-limiting example. It should be understood, however, that the example is illustrative only, should not be taken in any way as a restriction on the generality of the invention described above.

### EXAMPLE

Full normal regression example 201 data points 41 basis functions

k=0 and b=1e7

the correct four basis functions are identified namely 2 12 24 34

estimated variance is 0.67.

With k=0.2 and b=1e7

eight basis functions are identified, namely 2 8 12 16 19 24 34

estimated variance is 0.63. Note that the correct set of basis functions is included in this set.

The results of the iterations for k=0.2 and b=1e7 are given below.

EM Iteration: 0 expected post: 2 basis fns 41

sigma squared 0.6004567

EM Iteration: 1 expected post: −63.91024 basis fns 41

sigma squared 0.6037467

EM Iteration: 2 expected post: −52.76575 basis fns 41

sigma squared 0.6081233

EM Iteration: 3 expected post: −53.10084 basis fns 30

sigma squared 0.6118665

EM Iteration: 4 expected post: −53.55141 basis fns 22

sigma squared 0.6143482

EM Iteration: 5 expected post: −53.79887 basis fns 18

sigma squared 0.6155

EM Iteration: 6 expected post: −53.91096 basis fns 18

sigma squared 0.6159484

EM Iteration: 7 expected post: −53.94735 basis fns 16

sigma squared 0.6160951

EM Iteration: 8 expected post: −53.92469 basis fns 14

sigma squared 0.615873

EM Iteration: 9 expected post: −53.83668 basis fns 13

sigma squared 0.6156233

EM Iteration: 10 expected post: −53.71836 basis fns 13

sigma squared 0.6156616

EM Iteration: 11 expected post: −53.61035 basis fns 12

sigma squared 0.6157966

EM Iteration: 12 expected post: −53.52386 basis fns 12

sigma squared 0.6159524

EM Iteration: 13 expected post: −53.47354 basis fns 12

sigma squared 0.6163736

EM Iteration: 14 expected post: −53.47986 basis fns 12

sigma squared 0.6171314

EM Iteration: 15 expected post: −53.53784 basis fns 11

sigma squared 0.6182353

EM Iteration: 16 expected post: −53.63423 basis fns 11

sigma squared 0.6196385

EM Iteration: 17 expected post: −53.75112 basis fns 11

sigma squared 0.621111

EM Iteration: 18 expected post: −53.86309 basis fns 11

sigma squared 0.6224584

EM Iteration: 19 expected post: −53.96314 basis fns 11

sigma squared 0.6236203

EM Iteration: 20 expected post: −54.05662 basis fns 11

sigma squared 0.6245656

EM Iteration: 21 expected post: −54.1382 basis fns 10

sigma squared 0.6254182

EM Iteration: 22 expected post: −54.21169 basis fns 10

sigma squared 0.6259266

EM Iteration: 23 expected post: −54.25395 basis fns 9

sigma squared 0.6259266

EM Iteration: 24 expected post: −54.26136 basis fns 9

sigma squared 0.6260238

EM Iteration: 25 expected post: −54.25962 basis fns 9

sigma squared 0.6260203

EM Iteration: 26 expected post: −54.25875 basis fns 8

sigma squared 0.6260179

EM Iteration: 27 expected post: −54.25836 basis fns 8

sigma squared 0.626017

EM Iteration: 28 expected post: −54.2582 basis fns 8

sigma squared 0.6260166

For the reduced data set with 201 observations and 10 variables, k=0 and b=1e7

Gives the correct basis functions, namely 1 2 3 4. With k=0.25 and b=1e7, 7 basis functions were chosen, namely 1 2 3 4 6 8 9. A record of the iterations is given below.

Note that this set also includes the correct set.

EM Iteration: 0 expected post: 2 basis fns 10

sigma squared 0.6511711

EM Iteration: 1 expected post: −66.18153 basis fns 10

sigma squared 0.6516289

EM Iteration: 2 expected post: −57.69118 basis fns 10

sigma squared 0.6518373

EM Iteration: 3 expected post: −57.72295 basis fns 9

sigma squared 0.6518373

EM Iteration: 4 expected post: −57.74616 basis fns 8

sigma squared 0.65188

EM Iteration: 5 expected post: −57.75293 basis fns 7

sigma squared 0.6518781

### Ordered Categories Examples

Luo prostate data 15 samples 9605 genes. For k=0 and b=1e7 we get the following results

misclassification table

pred

| y | 1 | 2 | 3 | 4 |
|---|---|---|---|---|
| 1 | 4 | 0 | 0 | 0 |
| 2 | 0 | 2 | 1 | 0 |
| 3 | 0 | 0 | 4 | 0 |
| 4 | 0 | 0 | 0 | 4 |

Identifiers of variables left in ordered categories model 6611

For k=0.25 and b=le7 we get the following results

misclassification table

pred

| y | 1 | 2 | 3 | 4 |
|---|---|---|---|---|
| 1 | 4 | 0 | 0 | 0 |
| 2 | 0 | 3 | 0 | 0 |
| 3 | 0 | 0 | 4 | 0 |
| 4 | 0 | 0 | 0 | 4 |

Identifiers of variables left in ordered categories model 6611 7188

Note that we now have perfect discrimination on the training data with the addition of one extra variable. A record of the iterations of the algorithm is given below.

Iteration 1: 11 cycles, criterion −4.661957

misclassification matrix

$$fhat$$

$$\begin{matrix}f & & 1 & 2 \\ & 1 & 23 & 0 \\ & 2 & 0 & 22\end{matrix}$$

$$row = true class$$

Class 1 Number of basis functions in model: 9608

Iteration 2: 5 cycles, criterion −9.536942

misclassification matrix

$$fhat$$

$$\begin{matrix}f & & 1 & 2 \\ & 1 & 23 & 0 \\ & 2 & 1 & 21\end{matrix}$$

$$row = true class$$

Class 1 Number of basis functions in model: 6431

Iteration 3: 4 cycles, criterion −9.007843

misclassification matrix

$$fhat$$

$$\begin{matrix}f & & 1 & 2 \\ & 1 & 23 & 0 \\ & 2 & 0 & 22\end{matrix}$$

$$row = true class$$

Class 1 Number of basis functions in model: 508

Iteration 4: 5 cycles, criterion −6.47555

misclassification matrix

$$fhat$$

$$\begin{matrix}f & & 1 & 2 \\ & 1 & 23 & 0 \\ & 2 & 0 & 22\end{matrix}$$

$$row = true class$$

Class 1 Number of basis functions in model: 62

Iteration 5: 6 cycles, criterion −4.126996

misclassification matrix

$$fhat$$

$$\begin{matrix}f & & 1 & 2 \\ & 1 & 23 & 0 \\ & 2 & 1 & 21\end{matrix}$$

$$row = true class$$

Class 1 Number of basis functions in model: 20

Iteration 6: 6 cycles, criterion −3.047699

misclassification matrix

$$fhat$$

$$\begin{matrix}f & & 1 & 2 \\ & 1 & 23 & 0 \\ & 2 & 1 & 21\end{matrix}$$

$$row = true class$$

Class 1 Number of basis functions in model: 12

Iteration 7: 5 cycles, criterion −2.610974

misclassification matrix

$$fhat$$

$$\begin{matrix}f & & 1 & 2 \\ & 1 & 23 & 0 \\ & 2 & 1 & 21\end{matrix}$$

$$row = true class$$

Class 1: Variables left in model

1 2 3 408 846 6614 7191 8077

regression coefficients

28.81413 14.27784 7.025863 −1.086501e-06 4.553004e-09 −16.25844 0.1412991 −0.04101412

Iteration 8: 5 cycles, criterion −2.307441

misclassification matrix

$$fhat$$

$$\begin{matrix}f & & 1 & 2 \\ & 1 & 23 & 0 \\ & 2 & 1 & 21\end{matrix}$$

$$row = true class$$

Class 1: Variables left in model

1 2 3 6614 7191 8077

regression coefficients

32.66699 15.80614 7.86011 −18.53527 0.1808061 −0.006728619

Iteration 9: 5 cycles, criterion −2.028043

misclassification matrix

$$fhat$$

$$\begin{matrix}f & & 1 & 2 \\ & 1 & 23 & 0 \\ & 2 & 0 & 22\end{matrix}$$

$$row = true class$$

Class 1: Variables left in model

1 2 3 6614 7191 8077

regression coefficients

36.11990 17.21351 8.599812 −20.52450 0.2232955 −0.0001630341

Iteration 10: 6 cycles, criterion −1.808861

misclassification matrix

$$fhat$$

$$\begin{matrix}f & & 1 & 2 \\ & 1 & 23 & 0 \\ & 2 & 0 & 22\end{matrix}$$

$$row = true class$$

Class I: Variables left in model

1 2 3 6614 7191 8077

regression coefficients

39.29053 18.55341 9.292612 −22.33653 0.260273 −8.696388e-08

Iteration 11: 6 cycles, criterion −1.656129

misclassification matrix

$$\begin{matrix} & & fhat & \\ f & & 1 & 2 \\ & 1 & 23 & 0 \\ & 2 & 0 & 22\end{matrix}$$

$$row = true class$$

Class 1: Variables left in model

1 2 3 6614 7191

regression coefficients

42.01569 19.73626 9.90312 −23.89147 0.2882204

Iteration 12: 6 cycles, criterion −1.554494

misclassification matrix

$$\begin{matrix} & & fhat & \\ f & & 1 & 2 \\ & 1 & 23 & 0 \\ & 2 & 0 & 22\end{matrix}$$

$$row = true class$$

Class 1: Variables left in model

1 2 3 6614 7191

regression coefficients

44.19405 20.69926 10.40117 −25.1328 0.3077712

Iteration 13: 6 cycles, criterion −1.487778

misclassification matrix

$$\begin{matrix} & & fhat & \\ f & & 1 & 2 \\ & 1 & 23 & 0 \\ & 2 & 0 & 22\end{matrix}$$

$$row = true class$$

Class 1: Variables left in model

1 2 3 6614 7191

regression coefficients

45.84032 21.43537 10.78268 −26.07003 0.3209974

Iteration 14: 6 cycles, criterion −1.443949

misclassification matrix

$$\begin{matrix} & & fhat & \\ f & & 1 & 2 \\ & 1 & 23 & 0 \\ & 2 & 0 & 22\end{matrix}$$

$$row = true class$$

Class 1: Variables left in model

1 2 3 6614 7191

regression coefficients

47.03702 21.97416 11.06231 −26.75088 0.3298526

Iteration 15: 6 cycles, criterion −1.415

misclassification matrix

$$\begin{matrix} & & fhat & \\ f & & 1 & 2 \\ & 1 & 23 & 0 \\ & 2 & 0 & 22\end{matrix}$$

$$row = true class$$

Class 1: Variables left in model

1 2 3 6614 7191

regression coefficients

47.88472 22.35743 11.26136 −27.23297 0.3357765

Iteration 16: 6 cycles, criterion −1.395770

misclassification matrix

$$\begin{matrix} & & fhat & \\ f & & 1 & 2 \\ & 1 & 23 & 0 \\ & 2 & 0 & 22\end{matrix}$$

$$row = true class$$

Class 1: Variables left in model

1 2 3 6614 7191

regression coefficients

48.47516 22.62508 11.40040 −27.56866 0.3397475

Iteration 17: 5 cycles, criterion −1.382936

misclassification matrix

$$\begin{matrix} & & fhat & \\ f & & 1 & 2 \\ & 1 & 23 & 0 \\ & 2 & 0 & 22\end{matrix}$$

$$row = true class$$

Class 1: Variables left in model

1 2 3 6614 7191

regression coefficients

48.88196 22.80978 11.49636 −27.79991 0.3424153

Iteration 18: 5 cycles, criterion −1.374340

misclassification matrix

$$\begin{matrix} & & fhat & \\ f & & 1 & 2 \\ & 1 & 23 & 0 \\ & 2 & 0 & 22\end{matrix}$$

$$row = true class$$

Class 1: Variables left in model

1 2 3 6614 7191

regression coefficients

49.16029 22.93629 11.56209 −27.95811 0.3442109

Iteration 19: 5 cycles, criterion −1.368567

misclassification matrix

$$\begin{matrix} & & fhat & \\ f & & 1 & 2 \\ & 1 & 23 & 0 \\ & 2 & 0 & 22\end{matrix}$$

$$row = true class$$

Class 1: Variables left in model

1 2 3 6614 7191

regression coefficients

49.34987 23.02251 11.60689 −28.06586 0.3454208

Iteration 20: 5 cycles, criterion −1.364684

misclassification matrix

$$\begin{matrix} & & fhat & \\ f & & 1 & 2 \\ & 1 & 23 & 0 \\ & 2 & 0 & 22\end{matrix}$$

$$row = true class$$

Class 1: Variables left in model

1 2 3 6614 7191

regression coefficients

49.47861 23.08109 11.63732 −28.13903 0.3462368

Iteration 21: 5 cycles, criterion −1.362068

misclassification matrix

$$fhat$$

$$\begin{matrix}f & & 1 & 2 \\ & 1 & 23 & 0 \\ & 2 & 0 & 22\end{matrix}$$

$$row = true class$$

Class 1: Variables left in model

1 2 3 6614 7191

regression coefficients

49.56588 23.12080 11.65796 −28.18862 0.3467873

Iteration 22: 5 cycles, criterion −1.360305

misclassification matrix

$$fhat$$

$$\begin{matrix}f & & 1 & 2 \\ & 1 & 23 & 0 \\ & 2 & 0 & 22\end{matrix}$$

$$row = true class$$

Class 1: Variables left in model

1 2 3 6614 7191

regression coefficients

49.62496 23.14769 11.67193 −28.22219 0.3471588

Iteration 23: 4 cycles, criterion −1.359116

misclassification matrix

$$fhat$$

$$\begin{matrix}f & & 1 & 2 \\ & 1 & 23 & 0 \\ & 2 & 0 & 22\end{matrix}$$

$$row = true class$$

Class 1: Variables left in model

1 2 3 6614 7191

regression coefficients 49.6649 23.16588 11.68137 −28.2449 0.3474096

Iteration 24: 4 cycles, criterion −1.358314

misclassification matrix

$$fhat$$

$$\begin{matrix}f & & 1 & 2 \\ & 1 & 23 & 0 \\ & 2 & 0 & 22\end{matrix}$$

$$row = true class$$

Class 1: Variables left in model

1 2 3 6614 7191

regression coefficients

49.69192 23.17818 11.68776 −28.26025 0.3475789

Iteration 25: 4 cycles, criterion −1.357772

misclassification matrix

$$fhat$$

$$\begin{matrix}f & & 1 & 2 \\ & 1 & 23 & 0 \\ & 2 & 0 & 22\end{matrix}$$

$$row = true class$$

Class 1: Variables left in model

1 2 3 6614 7191

regression coefficients

49.71017 23.18649 11.69208 −28.27062 0.3476932

Iteration 26: 4 cycles, criterion −1.357407

misclassification matrix

$$fhat$$

$$\begin{matrix}f & & 1 & 2 \\ & 1 & 23 & 0 \\ & 2 & 0 & 22\end{matrix}$$

$$row = true class$$

Class 1: Variables left in model

1 2 3 6614 7191

regression coefficients

49.72251 23.19211 11.695 −28.27763 0.3477704

Iteration 27: 4 cycles, criterion −1.35716

misclassification matrix

$$fhat$$

$$\begin{matrix}f & & 1 & 2 \\ & 1 & 23 & 0 \\ & 2 & 0 & 22\end{matrix}$$

$$row = true class$$

Class 1: Variables left in model

1 2 3 6614 7191

regression coefficients

49.73084 23.19590 11.69697 −28.28237 0.3478225

Iteration 28: 3 cycles, criterion −1.356993

misclassification matrix

$$fhat$$

$$\begin{matrix}f & & 1 & 2 \\ & 1 & 23 & 0 \\ & 2 & 0 & 22\end{matrix}$$

$$row = true class$$

Class 1: Variables left in model

1 2 3 6614 7191

regression coefficients

49.73646 23.19846 11.6983 −28.28556 0.3478577

Iteration 29: 3 cycles, criterion −1.356881

misclassification matrix

$$fhat$$

$$\begin{matrix}f & & 1 & 2 \\ & 1 & 23 & 0 \\ & 2 & 0 & 22\end{matrix}$$

$$row = true class$$

Class 1: Variables left in model

1 2 3 6614 7191

regression coefficients

49.74026 23.20019 11.6992 −28.28772 0.3478814

Iteration 30: 3 cycles, criterion −1.356805

misclassification matrix

$$fhat$$

$$\begin{matrix}f & & 1 & 2 \\ & 1 & 23 & 0 \\ & 2 & 0 & 22\end{matrix}$$

$$row = true class$$

Class 1: Variables left in model

1 2 3 6614 7191

regression coefficients

49.74283 23.20136 11.69981 −28.28918 0.3478975

1

misclassification table

pred

| y | 1 | 2 | 3 | 4 |
|---|---|---|---|---|
| 1 | 4 | 0 | 0 | 0 |
| 2 | 0 | 3 | 0 | 0 |
| 3 | 0 | 0 | 4 | 0 |
| 4 | 0 | 0 | 0 | 4 |

Identifiers of variables left in ordered categories model

6611 7188

### Ordered Categories Example

Luo prostate data 15 samples 50 genes. For k=0 and b=1e7 we get the following results

misclassification table

pred

| y | 1 | 2 | 3 | 4 |
|---|---|---|---|---|
| 1 | 4 | 0 | 0 | 0 |
| 2 | 0 | 2 | 1 | 0 |
| 3 | 0 | 0 | 4 | 0 |
| 4 | 0 | 0 | 0 | 4 |

Identifiers of variables left in ordered categories model 1

For k=0.25 and b=1e7 we get the following results

misclassification table

pred

| y | 1 | 2 | 3 | 4 |
|---|---|---|---|---|
| 1 | 4 | 0 | 0 | 0 |
| 2 | 0 | 3 | 0 | 0 |
| 3 | 0 | 0 | 4 | 0 |
| 4 | 0 | 0 | 0 | 4 |

Identifiers of variables left in ordered categories model 1 42

A record of the iterations for k=0.25 and b=1e7 is given below

Iteration 1: 19 cycles, criterion −0.4708706

misclassification matrix

$$\begin{matrix} & fhat & \\ f & 1 & 2 \\ 1 & 23 & 0 \\ 2 & 0 & 22\end{matrix}$$

$$row = true class$$

Class 1 Number of basis functions in model: 53

Iteration 2 7 cycles, criterion −1.536822

misclassification matrix

$$\begin{matrix} & fhat & \\ f & 1 & 2 \\ 1 & 23 & 0 \\ 2 & 0 & 22\end{matrix}$$

$$row = true class$$

Class 1 Number of basis functions in model: 53

Iteration 3: 5 cycles, criterion −2.032919

misclassification matrix

$$\begin{matrix} & fhat & \\ f & 1 & 2 \\ 1 & 23 & 0 \\ 2 & 0 & 22\end{matrix}$$

$$row = true class$$

Class 1 Number of basis functions in model: 42

Iteration 4: 5 cycles, criterion −2.132546

misclassification matrix

$$\begin{matrix} & fhat & \\ f & 1 & 2 \\ 1 & 23 & 0 \\ 2 & 0 & 22\end{matrix}$$

$$row = true class$$

Class 1 Number of basis functions in model: 18

Iteration 5: 5 cycles, criterion −1.978462

misclassification matrix

$$\begin{matrix} & fhat & \\ f & 1 & 2 \\ 1 & 23 & 0 \\ 2 & 0 & 22\end{matrix}$$

$$row = true class$$

Class 1 Number of basis functions in model: 13

Iteration 6: 5 cycles, criterion −1.668212

misclassification matrix

$$\begin{matrix} & fhat & \\ f & 1 & 2 \\ 1 & 23 & 0 \\ 2 & 0 & 22\end{matrix}$$

$$row = true class$$

Class 1: Variables left in model

1 2 3 4 10 41 43 45

regression coefficients

34.13253 22.30781 13.04342 −16.23506 0.003213167 0.006582334 −0.0005943874 −3.557023

Iteration 7: 5 cycles, criterion −1.407871

misclassification matrix

$$\begin{matrix} & fhat & \\ f & 1 & 2 \\ 1 & 23 & 0 \\ 2 & 0 & 22\end{matrix}$$

$$row = true class$$

Class 1: Variables left in model

1 2 3 4 10 41 43 45

regression coefficients

36.90726 24.69518 14.61792 −17.16723 1.112172e-05 5.949931e-06 −3.892181e-08 −4.2906

Iteration 8: 5 cycles, criterion −1.244166

misclassification matrix

$$\begin{matrix} & fhat & \\ f & 1 & 2 \\ 1 & 23 & 0 \\ 2 & 0 & 22\end{matrix}$$

$$row = true class$$

Class 1: Variables left in model

1 2 3 4 10 45

regression coefficients

39.15038 26.51011 15.78594 −17.99800 1.125451e-10 −4.799167

Iteration 9: 5 cycles, criterion −1.147754

misclassification matrix

$$\begin{matrix} & fhat & \\ f & 1 & 2 \\ 1 & 23 & 0 \\ 2 & 0 & 22\end{matrix}$$

$$row = true class$$

Class 1: Variables left in model

1 2 3 4 45

regression coefficients

40.72797 27.73318 16.56101 −18.61816 −5.115492

Iteration 10: 5 cycles, criterion −1.09211

misclassification matrix

$$\begin{matrix} & fhat & \\ f & 1 & 2 \\ 1 & 23 & 0 \\ 2 & 0 & 22\end{matrix}$$

$$row = true class$$

Class 1: Variables left in model

1 2 3 4 45

regression coefficients

41.74539 28.49967 17.04204 −19.03293 −5.302421

Iteration 11: 5 cycles, criterion −1.060238

misclassification matrix

$$fhat$$

$$\begin{matrix}f & & 1 & 2 \\ & 1 & 23 & 0 \\ & 2 & 0 & 22\end{matrix}$$

$$row = true class$$

Class 1: Variables left in model

1 2 3 4 45

regression coefficients

42.36866 28.96076 17.32967 −19.29261 −5.410496

Iteration 12: 5 cycles, criterion −1.042037

misclassification matrix

$$fhat$$

$$\begin{matrix}f & & 1 & 2 \\ & 1 & 23 & 0 \\ & 2 & 0 & 22\end{matrix}$$

$$row = true class$$

Class 1: Variables left in model

1 2 3 4 45

regression coefficients

42.73908 29.23176 17.49811 −19.44894 −5.472426

Iteration 13: 5 cycles, criterion −1.031656

misclassification matrix

$$fhat$$

$$\begin{matrix}f & & 1 & 2 \\ & 1 & 23 & 0 \\ & 2 & 0 & 22\end{matrix}$$

$$row = true class$$

Class 1: Variables left in model

1 2 3 4 45

regression coefficients

42.95536 29.38894 17.59560 −19.54090 −5.507787

Iteration 14: 4 cycles, criterion −1.025738

misclassification matrix

$$fhat$$

$$\begin{matrix}f & & 1 & 2 \\ & 1 & 23 & 0 \\ & 2 & 0 & 22\end{matrix}$$

$$row = true class$$

Class 1: Variables left in model

1 2 3 4 45

regression coefficients

43.08034 29.47941 17.65163 −19.59428 −5.527948

Iteration 15: 4 cycles, criterion −1.022366

misclassification matrix

$$fhat$$

$$\begin{matrix}f & & 1 & 2 \\ & 1 & 23 & 0 \\ & 2 & 0 & 22\end{matrix}$$

$$row = true class$$

Class 1: Variables left in model

1 2 3 4 45

regression coefficients

43.15213 29.53125 17.68372 −19.62502 −5.539438

Iteration 16: 4 cycles, criterion −1.020444

misclassification matrix

$$fhat$$

$$\begin{matrix}f & & 1 & 2 \\ & 1 & 23 & 0 \\ & 2 & 0 & 22\end{matrix}$$

$$row = true class$$

Class 1: Variables left in model

1 2 3 4 45

regression coefficients

43.19322 29.56089 17.70206 −19.64265 −5.545984

Iteration 17: 4 cycles, criterion −1.019349

misclassification matrix

$$fhat$$

$$\begin{matrix}f & & 1 & 2 \\ & 1 & 23 & 0 \\ & 2 & 0 & 22\end{matrix}$$

$$row = true class$$

Class 1: Variables left in model

1 2 3 4 45

regression coefficients

43.21670 29.57780 17.71252 −19.65272 −5.549713

Iteration 18: 3 cycles, criterion −1.018725

misclassification matrix

$$fhat$$

$$\begin{matrix}f & & 1 & 2 \\ & 1 & 23 & 0 \\ & 2 & 0 & 22\end{matrix}$$

$$row = true class$$

Class 1: Variables left in model

1 2 3 4 45

regression coefficients

43.23008 29.58745 17.71848 −19.65847 −5.551837

Iteration 19: 3 cycles, criterion −1.01837

misclassification matrix

$$fhat$$

$$\begin{matrix}f & & 1 & 2 \\ & 1 & 23 & 0 \\ & 2 & 0 & 22\end{matrix}$$

$$row = true class$$

Class 1: Variables left in model

1 2 3 4 45

regression coefficients

43.23772 29.59295 17.72188 −19.66176 −5.553047

Iteration 20: 3 cycles, criterion −1.018167

misclassification matrix

$$fhat$$

$$\begin{matrix}f & & 1 & 2 \\ & 1 & 23 & 0 \\ & 2 & 0 & 22\end{matrix}$$

$$row = true class$$

Class 1: Variables left in model

1 2 3 4 45

regression coefficients

43.24208 29.59608 17.72382 −19.66363 −5.553737

Iteration 21: 3 cycles, criterion −1.018052

misclassification matrix

$$\begin{matrix} & & fhat & \\ f & & 1 & 2 \\ & 1 & 23 & 0 \\ & 2 & 0 & 22\end{matrix}$$

$$row = true class$$

Class 1: Variables left in model

1 2 3 4 45

regression coefficients

43.24456 29.59787 17.72493 −19.66469 −5.55413

Iteration 22: 3 cycles, criterion −1.017986

misclassification matrix

$$\begin{matrix} & & fhat & \\ f & & 1 & 2 \\ & 1 & 23 & 0 \\ & 2 & 0 & 22\end{matrix}$$

$$row = true class$$

Class 1: Variables left in model

1 2 3 4 45

regression coefficients

43.24598 29.59889 17.72556 −19.6653 −5.554354

1

misclassification table

pred

| y | 1 | 2 | 3 | 4 |
|---|---|---|---|---|
| 1 | 4 | 0 | 0 | 0 |
| 2 | 0 | 3 | 0 | 0 |
| 3 | 0 | 0 | 4 | 0 |
| 4 | 0 | 0 | 0 | 4 |

Identifiers of variables left in ordered categories model

1 42

1. A method of identifying a subset of components of a system based on data obtained from the system using at least one training sample from the system, the method comprising the steps of:
obtaining a linear combination of components of the system and weightings of the linear combination of components, the weightings having values based on data obtained from the at least one training sample, the at least one training sample having a known feature;
obtaining a model of a probability distribution of the known feature, wherein the model is conditional on the linear combination of components;
obtaining a prior distribution for the weighting of the linear combination of the components, the prior distribution comprising a hyperprior having a high probability density close to zero, the hyperprior being such that it is based on a combined Gaussian distribution and Gamma hyperprior;
combining the prior distribution and the model to generate a posterior distribution; and
identifying the subset of components based on a set of the weightings that maximise the posterior distribution.

2. The method as claimed in claim 1, wherein the step of obtaining the linear combination comprises the step of using a Bayesian statistical method to estimate the weightings.

3. The method as claimed in claim 2, further comprising the step of making an apriori assumption that a majority of the components are unlikely to be components that will form part of the subset of components.

4. The method as claimed in claim 3, wherein the hyperprior comprises one or more adjustable parameters that enable the prior distribution near zero to be varied.

5. The method as claimed in claim 4, wherein the model comprise a mathematical equation in the form of a likelihood function that provides the probability distribution based on data obtained from the at least one training sample.

6. The method as claimed in claim 5, wherein the likelihood function is based on a previously described model for describing some probability distribution.

7. The method as claimed in claim 6, wherein the step of obtaining the model comprises the step of selecting the model from a group comprising a multinomial or binomial logistic regression, generalised linear model, Cox's proportional hazards model, accelerated failure model and parametric survival model.

8. The method as claimed in claim 7, wherein the model based on the multinomial or binomial logistical regression is in the form of:
$$L = {\prod }_{l = 1}^{n} ( {\prod }_{g = 1}^{G - 1} {\{ \frac{{e}^{{x}_{i}^{T} {β}_{g}}}{( 1 + {\sum }_{g = 1}^{G - 1} {e}^{{x}_{i}^{T} {β}_{g}} )} \}}^{{e}_{ik}} {\{ \frac{1}{1 + {\sum }_{h = 1}^{G - 1} {e}^{{x}_{i}^{T} {β}_{h}}} \}}^{{e}_{iG}} )$$

9. The method as claimed in claim 7, wherein the model based on the generalised linear model is in the form of:
$$L = log p \text{(} y \vert β , ϕ ) = {\sum }_{i = 1}^{N} \{ \frac{{y}_{i} {θ}_{i} - b ( {θ}_{i} )}{{a}_{i} ( ϕ )} + c ( {y}_{i} , ϕ ) \}$$

10. The method as claimed in claim 7, wherein the model based on the Cox's proportional hazards model is in the form of:
$$l \text{(} {t}_{∼} \text{\textbar} {β}_{∼} \text{)} = {\prod }_{j = 1}^{N} {( \frac{exp ( {Z}_{j} {β}_{∼} )}{{\sum }_{i ∈ {ℜ}_{j}} exp ( {Z}_{i} {β}_{∼} )} )}^{{d}_{j}}$$

11. The method as claimed in claim 7, wherein the model based on the Parametric Survival model is in the form of:
$$L = {\sum }_{i = 1}^{N} \{ {c}_{i} log ( {μ}_{i} ) - {μ}_{i} + {c}_{i} ( log ( \frac{λ ( {y}_{i} )}{Λ ( {y}_{i} ; {φ}_{∼} )} ) ) \}$$

12. The method as claimed in claim 11, wherein the step of identifying the subset of components comprises the step of using an iterative procedure such that the probability density of the posterior distribution is maximised.

13. The method as claimed in claim 12, wherein the iterative procedure is an EM algorithm.

14. A method for identifying a subset of components of a subject which are capable of classifying the subject into one of a plurality of predefined groups, wherein each group is defined by a response to a test treatment, the method comprising the steps of:
exposing a plurality of subjects to the test treatment and grouping the subjects into response groups based on responses to the treatment;
measuring components of the subjects; and
identifying a subset of components that is capable of classifying the subjects into response groups using the method as claimed in claim 1.

15. An apparatus for identifying a subset of components of a subject, the subset being capable of being used to classify the subject into one of a plurality of predefined response groups wherein each response group, is formed by exposing a plurality of subjects to a test treatment and grouping the subjects into response groups based on the response to the treatment, the apparatus comprising:
an input for receiving measured components of the subjects; and
processing means operable to identify a subset of components that is capable of being used to classify the subjects into response groups using the method as claimed in claim 1.

16. A method for identifying a subset of components of a subject that is capable of classifying the subject as being responsive or non-responsive to treatment with a test compound, the method comprising the steps of:
exposing a plurality of subjects to the test compound and grouping the subjects into response groups based on each subjects response to the test compound;
measuring components of the subjects; and
identifying a subset of components that is capable of being used to classify the subjects into response groups using the method as claimed in claim 1.

17. An apparatus for identifying a subset of components of a subject, the subset being capable of being used to classify the subject into one of a plurality of predefined response groups wherein each response group is formed by exposing a plurality of subjects to a compound and grouping the subjects into response groups based on the response to the compound, the apparatus comprising;
an input operable to receive measured components of the subjects;
processing means operable to identify a subset of components that is capable of classifying the subjects into response groups using the method as claimed in any one of claim 1.

18. An apparatus for identifying a subset of components of a system from data generated from the system from a plurality of samples from the system, the subset being capable of being used to predict a feature of a test sample, the apparatus comprising:
a processing means operable to:
obtain a linear combination of components of the system and obtain weightings of the linear combination of components, each of the weightings having a value based on data obtained from at least one training sample, the at least one training sample having a known feature;
obtaining a model of a probability distribution of a second feature, wherein the model is conditional on the linear combination of components;
obtaining a prior distribution for the weightings of the linear combination of the components, the prior distribution comprising an adjustable hyperprior which allows the prior probability mass close to zero to be varied wherein the hyperprior is based on a combined Gaussian distribution and Gamma hyperprior;
combining the prior distribution and the model to generate a posterior distribution; and
identifying the subset of components having component weights that maximize the posterior distribution.

19. The apparatus as claimed in claim 18, wherein the processing means comprises a computer arranged to execute software.

20. A computer program which, when executed by a computing apparatus, allows the computing apparatus to carry out the method as claimed in claim 1.

21. A computer readable medium comprising the computer program as claimed in claim 20.

22. A method of testing a sample from a system to identify a feature of the sample, the method comprising the steps of testing for a subset of components that are diagnostic of the feature, the subset of components having been determined by using the method as claimed in claim 1.

23. The method as claimed in claim 22, wherein the system is a biological system.

24. An apparatus for testing a sample from a system to determine a feature of the sample, the apparatus comprising means for testing for components identified in accordance with the method as claimed in claim 1.

25. A computer program which, when executed by on a computing device, allows the computing device to carry out a method of identifying components from a system that are capable of being used to predict a feature of a test sample from the system, and wherein a linear combination of components and component weights is generated from data generated from a plurality of training samples, each training sample having a known feature, and a posterior distribution is generated by combining a prior distribution for the component weights comprising an adjustable hyperprior which allows the probability mass close to zero to be varied wherein the hyperprior is based on a combined Gaussian distribution and Gamma hyperprior, and a model that is conditional on the linear combination, to estimate component weights which maximise the posterior distribution.

26. A method of identifying a subset of components of a biological system, the subset being capable of predicting a feature of a test sample from the biological system, the method comprising the steps of:
obtaining a linear combination of components of the system and weightings of the linear combination of components, each of the weightings having a value based on data obtained from at least one training sample, the at least one training sample having a known feature;
obtaining a model of a probability distribution of the known feature, wherein the model is conditional on the linear combination of components;
obtaining a prior distribution for the weightings of the linear combination of the components, the prior distribution comprising an adjustable hyperprior which allows the probability mass close to zero to be varied;
combining the prior distribution and the model to generate a posterior distribution; and
identifying the subset of components based on the weightings that maximize the posterior distribution.
